(19) United States
(12) Patent Application Publication
(10) Pub. No.: US 2016/0077882 A1
(43) Pub. Date: Mar. 17, 2016

(54) SCHEDULING SYSTEM, SCHEDULING METHOD, AND RECORDING MEDIUM

(71) Applicant: NEC Corporation, Minato-ku, Tokyo (JP)

(72) Inventors: Takamichi Miyamoto, Tokyo (JP); Takeo Hosomi, Tokyo (JP)

(21) Appl. No.: 14/787,830

(22) PCT Filed: Mar. 18, 2014
(86) PCT No.: PCT/JP2014/001558

§ 371 Date: Oct. 29, 2015

(30) Foreign Application Priority Data
May 24, 2013 (JP) 2013-109843

(51) Int. Cl. G06F 9/50; G06F 9/48

(52) U.S. Cl. CPC G06F 9/5011; G06F 9/4881

(57) ABSTRACT

The present invention provides a scheduling system, etc., capable of more efficiently enabling the processing performance possessed by a resource to be exhibited. This scheduling system has a scheduler for reserving a second communication channel as a second communication resource in accordance with a fifth instruction for reserving the second communication channel from a first communication channel, the second communication channel being capable of transmitting/receiving first data between a memory and an accelerator memory, the first data being processed by a task, and the fifth instruction being included in tasks processed by a calculation processing device having such resources as a many-core accelerator, the accelerator memory, a processor, a memory, and the first communication channel, the first communication channel being capable of transmitting/receiving data between the many-core accelerator and the processor. The scheduler also determines a specific resource on the basis of the first data transmitted/received via the second communication channel, in accordance with a first instruction for reserving a resource.

### TECHNICAL FIELD

The present invention relates to a scheduling system, etc. that perform scheduling.

### BACKGROUND ART

A space division method is a scheduling method used in a multiprocessor system when a plurality of independent tasks is processed. Referring to FIG. 17, a configuration included in a system 54 that adopts a space division method will be described. FIG. 17 is a block diagram illustrating a configuration of a computer system (calculation processing system, information processing system, hereinafter also simply referred to as “system”) that adopts a space division method related to the present invention.

Referring to FIG. 17, the system 54 includes a server 40 including a processor 41, a processor 42, a processor 43, a processor 44, etc., a task scheduler 45, and a server resource management unit 46.

The task scheduler 45 receives a task to be executed as an input. Then, the task scheduler 45 reserves, by referencing the number of processors required for executing the received task and information about usage status of a plurality of processors (the processors 41 to 44) held by the server resource management unit 46, a processor (or processors) required for the execution. Then, the task scheduler 45 updates information held by the server resource management unit 46 and puts the task to the server 40. The task scheduler 45 updates the information held by the server resource management unit 46 after detecting completion of task execution by the server 40. The task scheduler 45 releases the processor reserved for processing the task.

The task scheduler 45 uses the processors (the processors 41 to 44) included in the server 40 for processing a plurality of tasks in accordance with the aforementioned operation. Thus, processing performance in the server 40 improves.

On the other hand, as illustrated in FIG. 18, a server including a configuration different from the aforementioned configuration also exists. FIG. 18 is a block diagram illustrating a configuration of a system including a many-core accelerator as a technology related to the present invention. Referring to FIG. 18, a server 47 includes a host processor 48 and a main storage apparatus (main memory, memory, hereinafter referred to as “main memory”) 50 accessed by the host processor 48. Further, the server 47 includes a many-core accelerator (also referred to as “multi-core accelerator” or “multiple core accelerator”) 49. Furthermore, the server 47 includes an accelerator memory 51 accessed by the many-core accelerator 49.

Referring to FIG. 19, a configuration included in a system in which the server 47 including such a configuration as described above adopts such a task scheduling technology as described above will be described. FIG. 19 is a block diagram illustrating a configuration of a task scheduler for a system including a many-core accelerator as a technology related to the present invention. Referring to FIG. 19, a system 55 includes a task scheduler 52, a server resource management unit 53, and a server 47.

FIG. 20 illustrates processes when a server including a many-core accelerator illustrated in FIG. 18 adopts such a task scheduling method as described above. FIG. 20 is a flowchart (sequence diagram) illustrating a flow of processes in a task scheduler as a technology related to the present invention.

Referring to FIGS. 19 and 20, the task scheduler 52 receives a task to be executed as an input, and references resource information related to the host processor 48 and the many-core accelerator 49, required for executing the task. Then, the task scheduler 52 reserves a resource required for processing the task by referencing information about usage status of a resource managed by the server resource management unit 53 (Step S40). Then, the task scheduler 52 puts the task to the server 47 by specifying the reserved resource (Step S41). The task scheduler 52 transmits a signal indicating completion of the task to the server resource management unit 53 and releases the resource reserved for processing the task (Step S42) when detecting the completion of task processing by the server 47.

Referring to FIG. 21, processes performed by the server 47 for execution of one task will be described. FIG. 21 is a flowchart illustrating a flow of processes in a system including a many-core accelerator related to the present invention.

Referring to FIGS. 19 and 21, the server 47 receives a task put by the task scheduler 52 and starts processing of the task on the host processor 48 (Step S43). Then, the host processor 48 transmits data to be processed in the many-core accelerator 49 from the main memory 50 to the accelerator memory 51 (Step S44). The many-core accelerator 49 processes data transmitted by the host processor 48 (Step S45). Then, the host processor 48 transmits a result of processing by the many-core accelerator 49 from the accelerator memory 51 to the main memory 50 (Step S46). Then, the host processor 48 processes a next task (Step S43 or S44). The server 47 completes task processing in the host processor 48 by repeating the processes in Steps S43 to S46 at least once. The server 47 transmits a signal indicating completion of processing of the task to the task scheduler 52 (Step S47).

A program execution control method disclosed in PTL 1 represents a method for power-saving control in a system including different types of processors. In other words, the execution control method is a control method for performance improvement. In accordance with the execution control method, a clock frequency is changed so that respective processors complete split tasks simultaneously.

A data processing apparatus disclosed in PTL 2 reduces overhead required for saving and restoration, depending on progress status of the interrupted process when interrupting a process in data processing to give priority to another process.

In a data processing apparatus disclosed by PTL 3, software executed on a processor and hardware dedicated to a specific process are carried out in order of priority. The data processing apparatus enhances processing efficiency related to task switching.

### CITATION LIST

### Patent Literature

[PTL 1] Japanese Laid-open Patent Application No. 2011-197803

[PTL 2] Japanese Laid-open Patent Application No. 2010-181989

[PTL 3] Japanese Laid-open Patent Application No. 2007-102399

### SUMMARY OF INVENTION

### Technical Problem

Referring to FIGS. 19 and 21, a problem that occurs when a server 47 including a many-core accelerator 49 adopts such a task scheduling system as described above will be described.

A task scheduler 52 allocates a task to a resource by managing a resource in the many-core accelerator 49 when putting a task to the server 47. The task scheduler 52 releases the allocated resource when completing the task. In FIG. 19, the task scheduler 52 reserves a resource in the many-core accelerator 49 when putting a task to the server 47. The task scheduler 52 continues reserving the resource until completing the task. Therefore, the task scheduler 52 continues reserving the resource while the host processor 48 executes processing of a task in Step S43 or S47. Further, the task scheduler 52 continues reserving the resource while the host processor 48 transmits data between a main memory 50 and an accelerator memory 51 in Steps S44, S46, etc.

Further, the task scheduler 52 reserves a maximum resource for processing the series of tasks on task activation even if a resource of the many-core accelerator 49 required for processing a series of tasks changes. Therefore, when a specific task using just part of a resource is processed in the series of tasks, there is a redundant resource that does not perform a process in Step S45. A problem that, as described above, there is a redundant resource that does not perform a specific process when a series of tasks are processed is referred to as an unused resource problem.

On the other hand, there exists a method in which, in order to avoid the aforementioned unused resource problem, the task scheduler 52 recognizes that the many-core accelerator 49 holds a more resource than the actual resource. However, as a result of avoiding the unused resource problem by such a method as described above, a resource of the many-core accelerator 49 becomes insufficient for actually processing a task. Therefore, the many-core accelerator 49 fails to process the task, or task processing becomes an excessively heavy load in the many-core accelerator 49. Consequently, processing performance possessed by a system 55 degrades.

In other words, a task scheduler 52 that adopts such a processing method as described above is not able to avoid the unused resource problem. Therefore, the many-core accelerator 49 degrades processing performance or fails task processing.

A main objective of the present invention is to provide a scheduling system, etc. more efficiently enabling processing performance possessed by a resource to be exhibited.

### Solution to Problem

In order to achieve the object mentioned above, a scheduling system includes the following configuration.

In other word, a scheduling system including:

a scheduler configured to reserve a second communication channel, that is capable of transmitting/receiving a first data processed by a task between the memory and the accelerator memory, as a second communication resource in accordance with a fifth instruction for reserving the second communication channel from a first communication channel that is capable of transmitting/receiving data between a many-core accelerator to be a resource and a processor which controls the resource, and determine a specific resource for processing the task by referring to the first data transmitted/received via the second communication resource in accordance with a first instruction for reserving the resource; wherein

the task is processed by a calculation processing apparatus which includes the many-core accelerator, an accelerator memory accessed by the many-core accelerator, the processor, a memory accessed by the processor, and a first communication channel.

Also, as another aspect of the present invention, a scheduling method includes:

reserving a second communication channel, that is capable of transmitting/receiving a first data processed by a task between the memory and the accelerator memory, as a second communication resource in accordance with a fifth instruction for reserving the second communication channel from a first communication channel that is capable of transmitting/receiving data between a many-core accelerator to be a resource and a processor which controls the resource; and

determining a specific resource for processing the task by referring to the first data transmitted/received via the second communication resource in accordance with a first instruction for reserving the resource; wherein

the task is processed by a calculation processing apparatus which includes the many-core accelerator, an accelerator memory accessed by the many-core accelerator, the processor, a memory accessed by the processor, and a first communication channel.

Furthermore, the object is also realized by a scheduling program, and a computer-readable recording medium which records the scheduling program.

### Advantageous Effects of Invention

A scheduling system, etc. according to the present invention is capable of more efficiently enabling processing performance possessed by a resource to be exhibited.

### BRIEF DESCRIPTION OF THE DRAWINGS

FIG. 1 is a block diagram illustrating a configuration of a scheduling system according to a first exemplary embodiment of the present invention.

FIG. 2 is a sequence diagram illustrating a flow of processes in the scheduling system according to the first exemplary embodiment.

FIG. 3 is a block diagram illustrating a configuration of a scheduling system according to a second exemplary embodiment of the present invention.

FIG. 4 is a sequence diagram illustrating a flow of processes in the scheduling system according to the second exemplary embodiment.

FIG. 5 is a block diagram illustrating a configuration of a scheduling system according to a third exemplary embodiment of the present invention.

FIG. 6 is a sequence diagram illustrating a flow of processes in the scheduling system according to the third exemplary embodiment.

FIG. 7 is a block diagram illustrating a configuration of a scheduling system according to a fourth exemplary embodiment of the present invention.

FIG. 8 is a sequence diagram illustrating a flow of processes in the scheduling system according to the fourth exemplary embodiment.

FIG. 9 is a sequence diagram illustrating a second flow of processes in the scheduling system according to the fourth exemplary embodiment.

FIG. 10 is a block diagram illustrating a configuration of a scheduling system according to a fifth exemplary embodiment of the present invention.

FIG. 11 is a sequence diagram illustrating a flow of processes in the scheduling system according to the fifth exemplary embodiment.

FIG. 12 is a block diagram illustrating a configuration of a scheduling system according to a sixth exemplary embodiment of the present invention.

FIG. 13 is a sequence diagram illustrating a flow of processes in the scheduling system according to the sixth exemplary embodiment.

FIG. 14 is a block diagram illustrating a configuration of a scheduling system according to a seventh exemplary embodiment of the present invention.

FIG. 15 is a sequence diagram illustrating a flow of processes in the scheduling system according to the seventh exemplary embodiment.

FIG. 16 is a schematic block diagram illustrating a hardware configuration of a calculation processing apparatus capable of realizing a scheduling system according to each exemplary embodiment of the present invention.

FIG. 17 is a block diagram illustrating a configuration of a system adopting a space division method related to the present invention.

FIG. 18 is a block diagram illustrating a configuration of a system including a many-core accelerator related to the present invention.

FIG. 19 is a block diagram illustrating a configuration of a task scheduler for a system including a many-core accelerator related to the present invention.

FIG. 20 is a flowchart illustrating a flow of processes in a task scheduler related to the present invention.

FIG. 21 is a flowchart illustrating a flow of processes in a system including a many-core accelerator related to the present invention.

FIG. 22 is a block diagram illustrating a configuration of a scheduling system according to an eighth exemplary embodiment of the present invention.

FIG. 23 is a sequence diagram illustrating a flow of processes in the scheduling system according to the eighth exemplary embodiment.

FIG. 24 is a sequence diagram illustrating a flow of processes executed by a scheduling system when a scheduler reserves a storage area on an accelerator memory in the eighth exemplary embodiment.

FIG. 25 is a block diagram illustrating a configuration of a scheduling system according to a ninth exemplary embodiment of the present invention.

FIG. 26 is a flowchart illustrating a flow of processes when a fifth instruction or a seventh instruction is received in the scheduling system according to the ninth exemplary embodiment.

FIG. 27 is a flowchart illustrating a flow of processes when a sixth instruction or an eighth instruction is received in the scheduling system according to the ninth exemplary embodiment.

FIG. 28 is a conceptual diagram illustrating an example of a task identifier that can be stored in a communication information unit.

FIG. 29 is a block diagram illustrating a configuration of a scheduling system according to a tenth exemplary embodiment of the present invention.

FIG. 30 is a flowchart illustrating a flow of processes in a priority order setting unit according to the tenth exemplary embodiment.

FIG. 31 is a flowchart illustrating a flow of processes in a communication control unit according to the tenth exemplary embodiment.

FIG. 32 is a conceptual diagram illustrating information that can be stored in the communication information unit according to the tenth exemplary embodiment.

FIG. 33 is a flowchart illustrating an example of a flow of processes in a predetermined priority order calculation method according to the tenth exemplary embodiment.

FIG. 34 is a flowchart illustrating an example of a flow of processes in a predetermined priority order calculation method according to the tenth exemplary embodiment.

FIG. 35 is a flowchart illustrating an example of a flow of processes in a predetermined priority order calculation method according to the tenth exemplary embodiment.

FIG. 36 is a flowchart illustrating an example of a flow of processes in a predetermined priority order calculation method according to the tenth exemplary embodiment.

FIG. 37 is a block diagram illustrating a configuration of a scheduling system according to an eleventh exemplary embodiment of the present invention.

FIG. 38 is a sequence diagram illustrating a flow of processes in the scheduling system according to the eleventh exemplary embodiment.

### EXEMPLARY EMBODIMENT

Next, exemplary embodiments of the present invention will be described in detail with reference to drawings.

### First Exemplary Embodiment

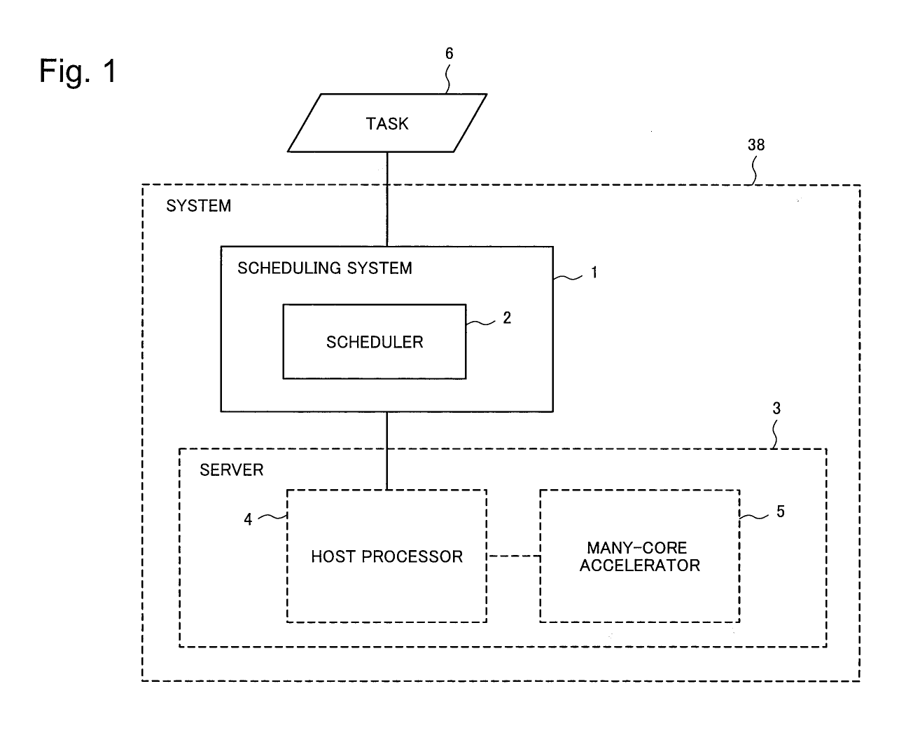

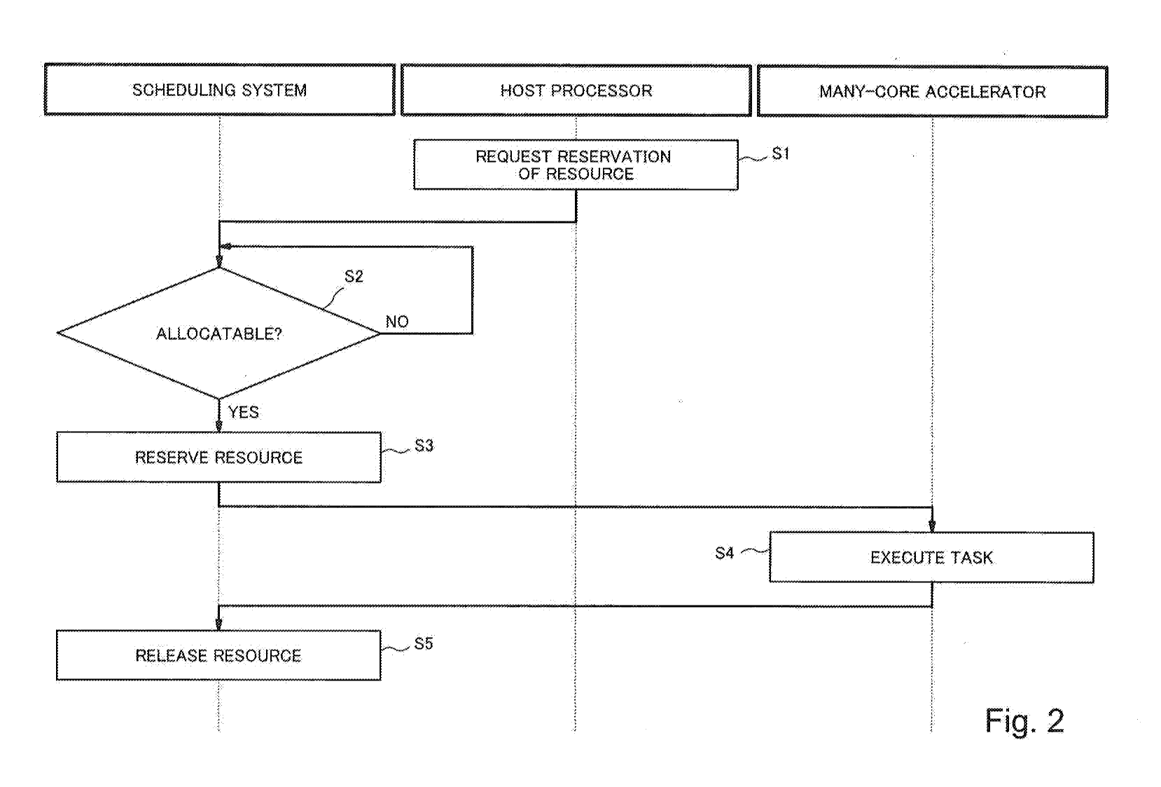

A configuration included in a scheduling system 1 according to a first exemplary embodiment of the present invention and processes performed by the scheduling system 1 will be described in detail referring to FIGS. 1 and 2. FIG. 1 is a block diagram illustrating a configuration of the scheduling system 1 according to the first exemplary embodiment of the present invention. FIG. 2 is a sequence diagram illustrating a flow of processes in the scheduling system 1 according to the first exemplary embodiment.

Referring to FIG. 1, a system 38 includes a server 3 (also referred to as “computer,” “calculation processing apparatus,” or “information processing apparatus”) that performs processing on a task 6 being a series of processes processed by a computer, and the scheduling system 1 according to the first exemplary embodiment. The scheduling system 1 includes a scheduler 2. The server 3 includes a host processor 4 (hereinafter also simply referred to as “processor”) and a many-core accelerator 5.

The host processor 4 performs processing such as control related to the many-core accelerator 5. First, the host processor 4 starts processing of the task 6. The host processor 4 reads an instruction (also referred to as command; hereinafter an instruction for reserving a resource is also referred to as “first instruction”) to reserve a resource (many-core accelerator 5) from the task 6. Then, the host processor 4 transmits a command for reserving a resource to the scheduling system 1 in accordance with the read first instruction (Step S1).

Next, the scheduler 2 checks whether or not a resource (hereinafter abbreviated as “resource reservation”) for the task 6 is allocatable when receiving the command (Step S2). The scheduler 2 reserves a resource (Step S3) when resource a resource is decided to be allocatable (YES in Step S2). The scheduler 2 checks again whether or not resource reservation is possible (Step S2) when resource is decided not to be allocatable (NO in Step S2), When the scheduler 2 decides that resource is allocatable (YES in Step S2), the many-core accelerator 5 executes the task 6 (Step S4).

When resource is decided not to be allocatable (NO in Step S2), the scheduler 2 waits for the resource to be released by performing the aforementioned process. Then, the scheduler 2 releases the reserved resource (Step S5).

The scheduling system 1 may be realized as, for example, a function in an operating system. The scheduling system 1 may also, for example, perform such a process as described above by transmitting/receiving a parameter, etc. related to a resource to/from an operating system.

As described in “BACKGROUND ART” a system described in PTL 1 to PTL 3 continues reserving a maximum resource that processes a series of tasks during a period between start and end of task processing. Therefore, when processing of a series of tasks uses only part of a resource, some part of the resource does not perform processing.

On the other hand, the scheduling system 1 according to the first exemplary embodiment reserves a resource in accordance with a request from a task, and then the reserved resource performs processing. The scheduling system 1 releases the resource by the host processor 4 commanding release of the resource. Even when the server 3 processes a series of tasks, the scheduling system 1 is able to allocate a resource for processing each task depending on task processing. Therefore, the scheduling system 1 according to the first exemplary embodiment is capable of, even when a series of tasks are processed, alleviating a situation in which only part of a resource performs processing.

In other words, the scheduling system 1 according to the first exemplary embodiment is capable of more efficiently enabling processing performance possessed by a resource to be exhibited.

### Second Exemplary Embodiment

Next, a second exemplary embodiment based on the aforementioned first exemplary embodiment will be described.

In the following description, characteristic matters according to the present exemplary embodiment will be mainly described and an overlapping description of the same configuration as in the aforementioned first exemplary embodiment will be omitted by assigning the same reference sign thereto.

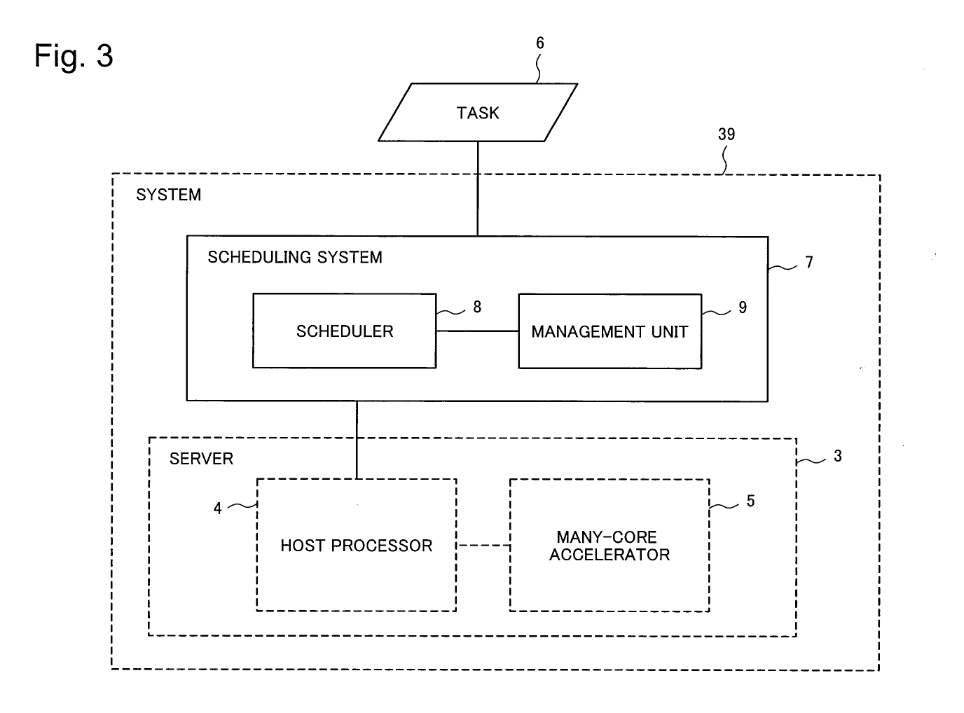

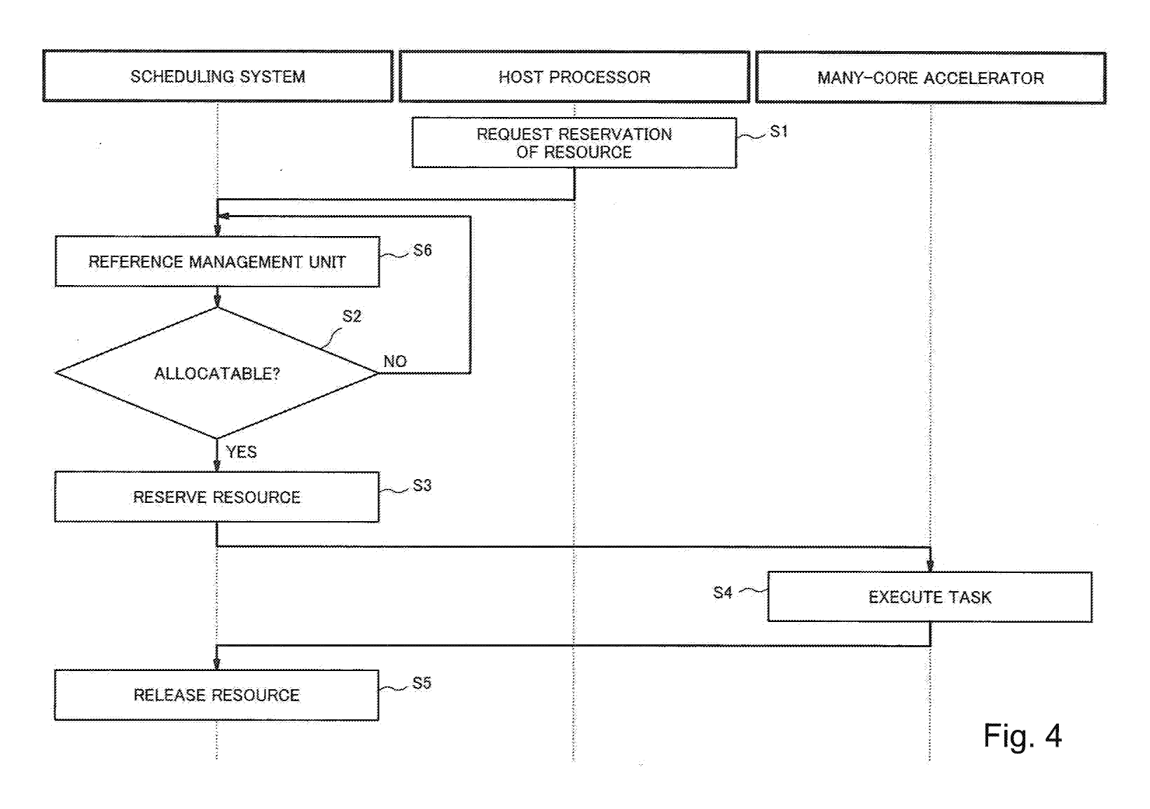

Referring to FIGS. 3 and 4, a configuration included in a scheduling system 7 according to the second exemplary embodiment of the present invention and processes performed by the scheduling system 7 will be described. FIG. 3 is a block diagram illustrating a configuration of the scheduling system 7 according to the second exemplary embodiment of the present invention. FIG. 4 is a sequence diagram illustrating a flow of processes in the scheduling system 7 according to the second exemplary embodiment.

Referring to FIG. 3, a system 39 includes the scheduling system 7 and the server 3. Further, the scheduling system 7 includes a scheduler 8 and a management unit 9. The management unit 9 manages usage status related to a resource included in the many-core accelerator 5. The scheduler 8, when receiving a request for reserving a resource (Step S1), reads information about usage status of the server 3 from the management unit 9 (Step S6). Then, the scheduler 8 decides, on the basis of the read information, whether or not a resource can be allocated (Step S2).

Since the management unit 9 manages information about usage status of a resource, the scheduler 8 is able to decide whether or not a resource can be allocated without referencing the outside. Therefore, the scheduling system 7 according to the second exemplary embodiment provides efficient management of a resource. Further, since the second exemplary embodiment includes a similar configuration to the first exemplary embodiment, the second exemplary embodiment can enjoy the similar effect to the first exemplary embodiment.

In other words, the scheduling system 7 according to the second exemplary embodiment is capable of more efficiently enabling processing performance possessed by a resource to be exhibited.

### Third Exemplary Embodiment

Next, a third exemplary embodiment based on the aforementioned first exemplary embodiment will be described.

In the following description, characteristic matters according to the present exemplary embodiment will be mainly described and an overlapping description of the same configuration as in the aforementioned first exemplary embodiment will be omitted by assigning the same reference sign thereto.

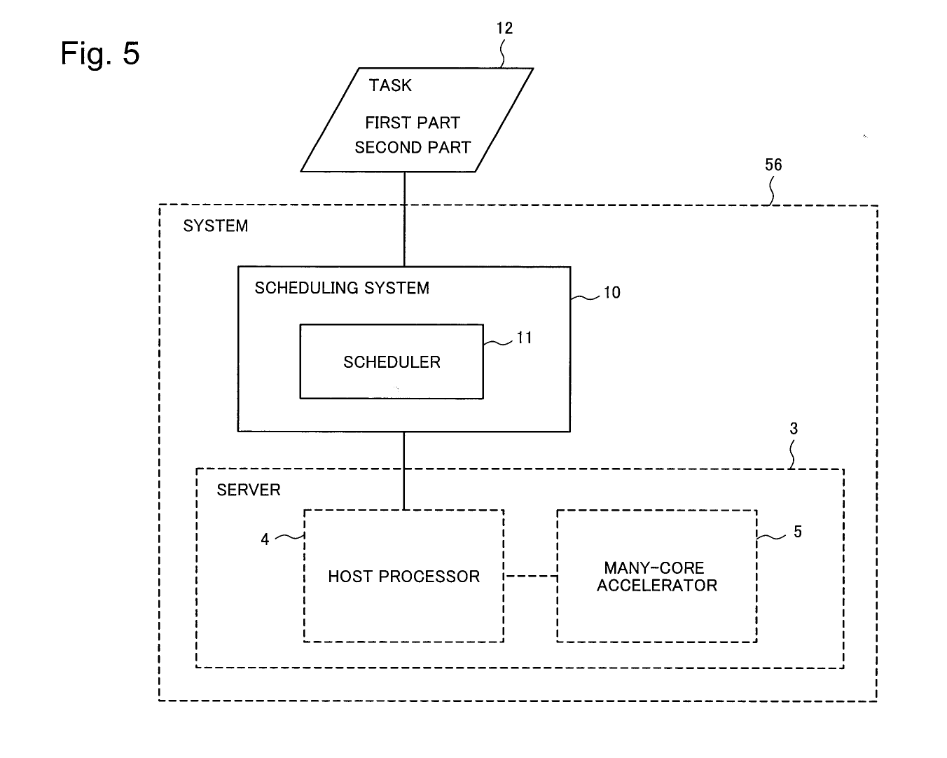

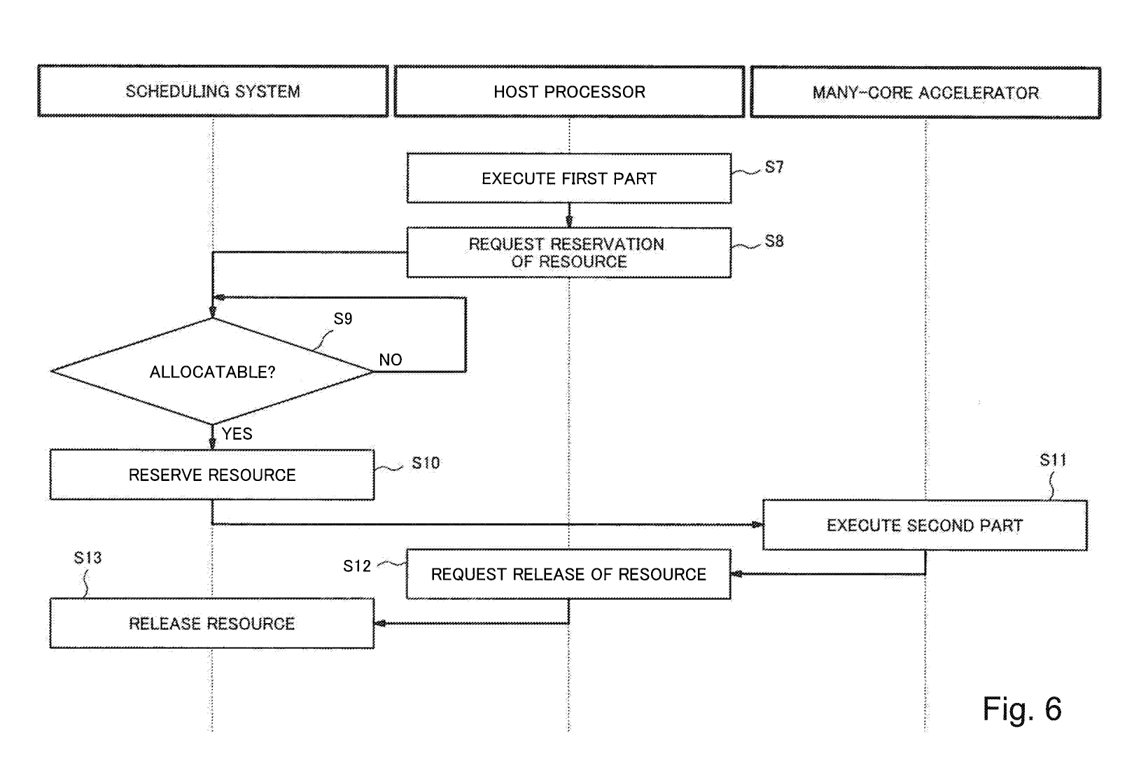

Referring to FIGS. 5 and 6, a configuration included in a scheduling system 10 according to the third exemplary embodiment of the present invention and processes performed by the scheduling system 10 will be described. FIG. 5 is a block diagram illustrating a configuration of the scheduling system 10 according to the third exemplary embodiment of the present invention. FIG. 6 is a sequence diagram illustrating a flow of processes in the scheduling system 10 according to the third exemplary embodiment.

Referring to FIG. 5, the scheduling system 10 includes a scheduler 11. A system 56 performs processing related to a task 12 including a first part and a second part by the server 3.

A host processor 4 executes the first part to be processed by the host processor 4 in the task 12 (Step S7). Then, the host processor 4 transmits a command for reserving a resource to the scheduler 11 in accordance with a first instruction (Step S8). When a resource is decided to be allocatable (YES in Step S9), the scheduler 11 reserves a resource (Step S10). When a resource is decided not to be allocatable (NO in Step S9), the scheduler 11 decides again whether or not a resource is allocatable (Step S9).

Next, the resource (included in the many-core accelerator 5) reserved by the scheduler 11 executes the second part to be processed by the resource (Step S11). Then, the host processor 4 issues a command for releasing the resource to the scheduler 11 in response to receiving a command for releasing the resource reserved by the scheduler 11 (hereinafter this command is referred to as “second instruction”) (Step S12). The scheduler 11 releases the reserved resource (Step S13) in response to receiving the command.

The first instruction includes, for example, information about the number of processors, etc. While the scheduler 11 determines an amount of resource on the basis of the aforementioned number of processors, etc., the amount of resource does not necessarily need to be equivalent to the aforementioned value. Further, the scheduler 11 may transmit information about a reserved resource. The information about the reserved resource may include information about the number of reserved processors, a list of available processor numbers, etc.

The task 12 includes the first part processed by the host processor 4, the second part, and the first instruction that reserves a resource for execution of the second part. Therefore, the scheduler 11 reserves a required resource before processing of the second part, and releases the resource after the reserved resource completes processing of the second part. In other words, the scheduling system 10 according to the third exemplary embodiment provides more detailed resource management compared with a system disclosed in PTL 1 to 3.

In other words, the scheduling system 10 according to the third exemplary embodiment is capable of more efficiently enabling processing performance possessed by a resource to be exhibited.

While, for convenience of description, the third exemplary embodiment is based on the first exemplary embodiment in the aforementioned description, the third exemplary embodiment may also be based on the second exemplary embodiment. In that case, the third exemplary embodiment can enjoy the similar effect to the second exemplary embodiment.

### Fourth Exemplary Embodiment

Next, a fourth exemplary embodiment based on the aforementioned first exemplary embodiment will be described.

In the following description, characteristic matters according to the present exemplary embodiment will be mainly described and an overlapping description of the same configuration as in the aforementioned first exemplary embodiment will be omitted by assigning the same reference sign thereto.

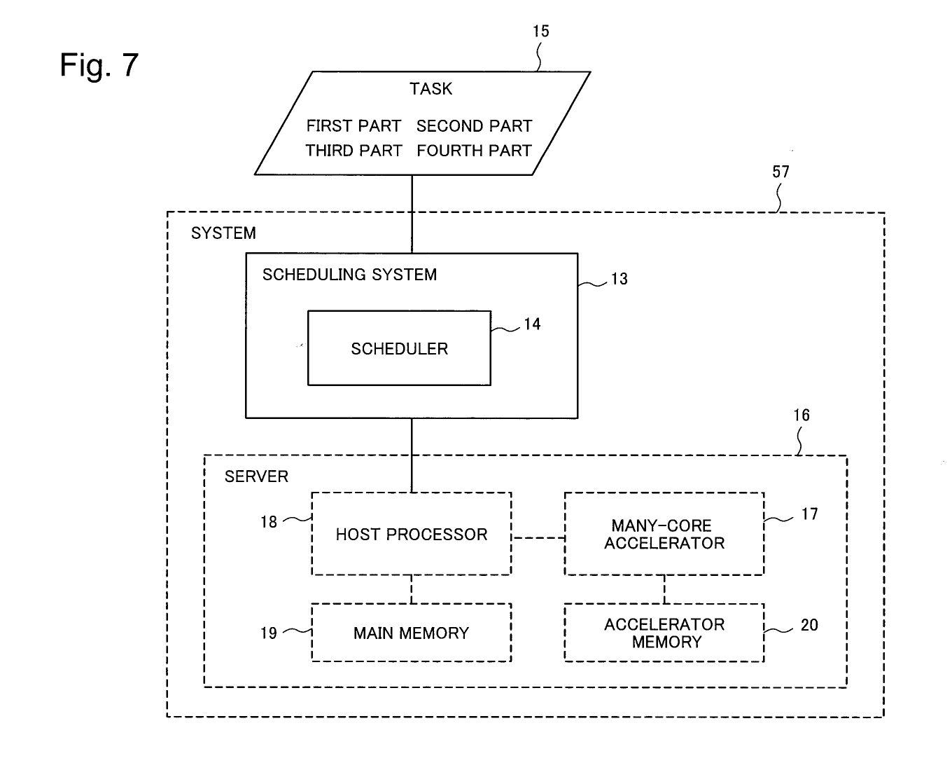

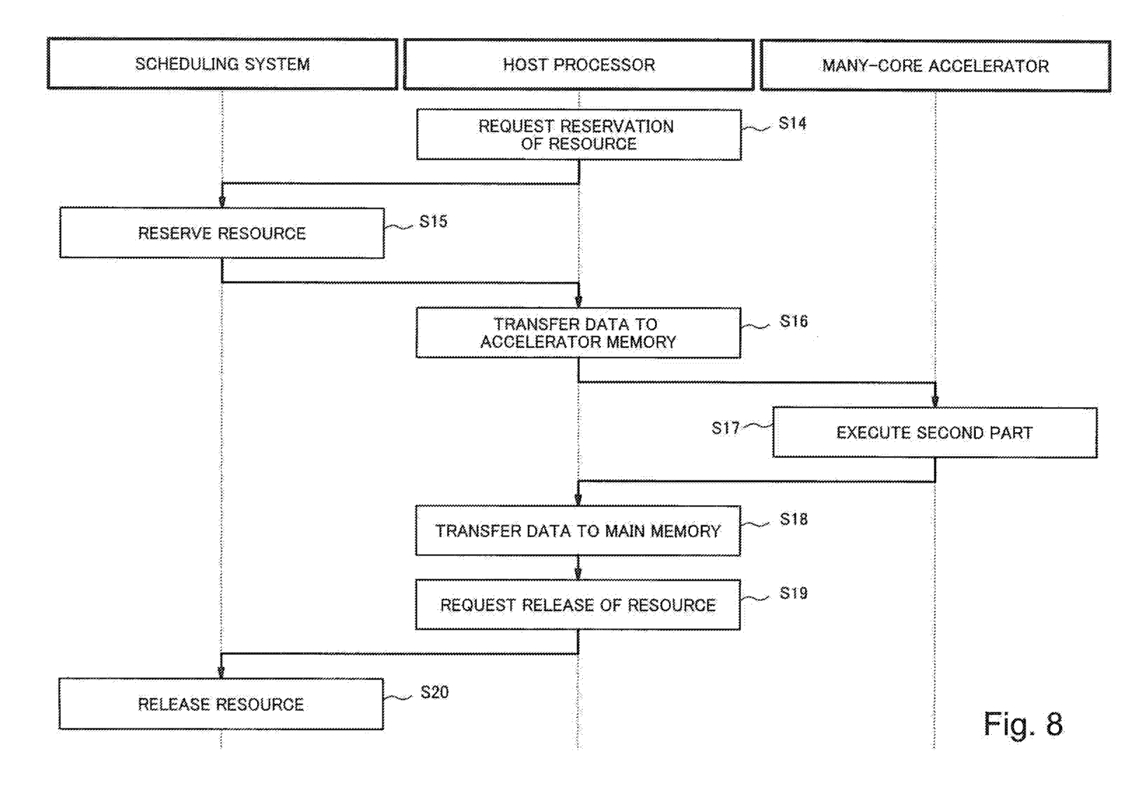

Referring to FIGS. 7 and 8, a configuration included in a scheduling system 13 according to the fourth exemplary embodiment of the present invention and processes performed by the scheduling system 13 will be described. FIG. 7 is a block diagram illustrating a configuration of the scheduling system 13 according to the fourth exemplary embodiment of the present invention. FIG. 8 is a sequence diagram illustrating a flow of processes in the scheduling system 13 according to the fourth exemplary embodiment.

Referring to FIG. 7, a system 57 includes a server 16 that processes a task 15 and a scheduling system 13 that manages a resource in the server 16.

The server 16 includes a host processor 18, a main memory 19 that stores data processed by the host processor 18, a many-core accelerator 17, and an accelerator memory 20 that stores data processed by the many-core accelerator 17.

The scheduling system 13 includes a scheduler 14. The task 15 includes, in addition to the aforementioned first part, first instruction, and second part, a third part that is an instruction for transmitting data from the main memory 19 to the accelerator memory 20 and a fourth part that is an instruction for transmitting data from the accelerator memory 20 to the main memory 19.

In accordance with the first instruction after executing the first part, the host processor 18 transmits a request for reserving a specific resource to the scheduling system 13 (Step S14). The scheduler 14 reserves a specific resource after receiving the request (Step S15). Step S15 is a collective expression including a series of processes in Steps S2 and S3 in FIG. 2, or a series of processes in Steps S2, S3, and S6 in FIG. 4. Next, the host processor 18 transmits data processed by the many-core accelerator 17 from the main memory 19 to the accelerator memory 20 (Step S16).

Next, the specific resource reserved by the scheduler 14 executes the second part (Step S17). Then, the host processor 18 transmits data processed by the specific resource from the accelerator memory 20 to the main memory 19 (Step S18). Then, the host processor 18 transmits a request for releasing the specific resource to the scheduling system 13 in accordance with the second instruction (Step S19). Then, the scheduler 14 releases the specific resource after receiving the request (Step S20).

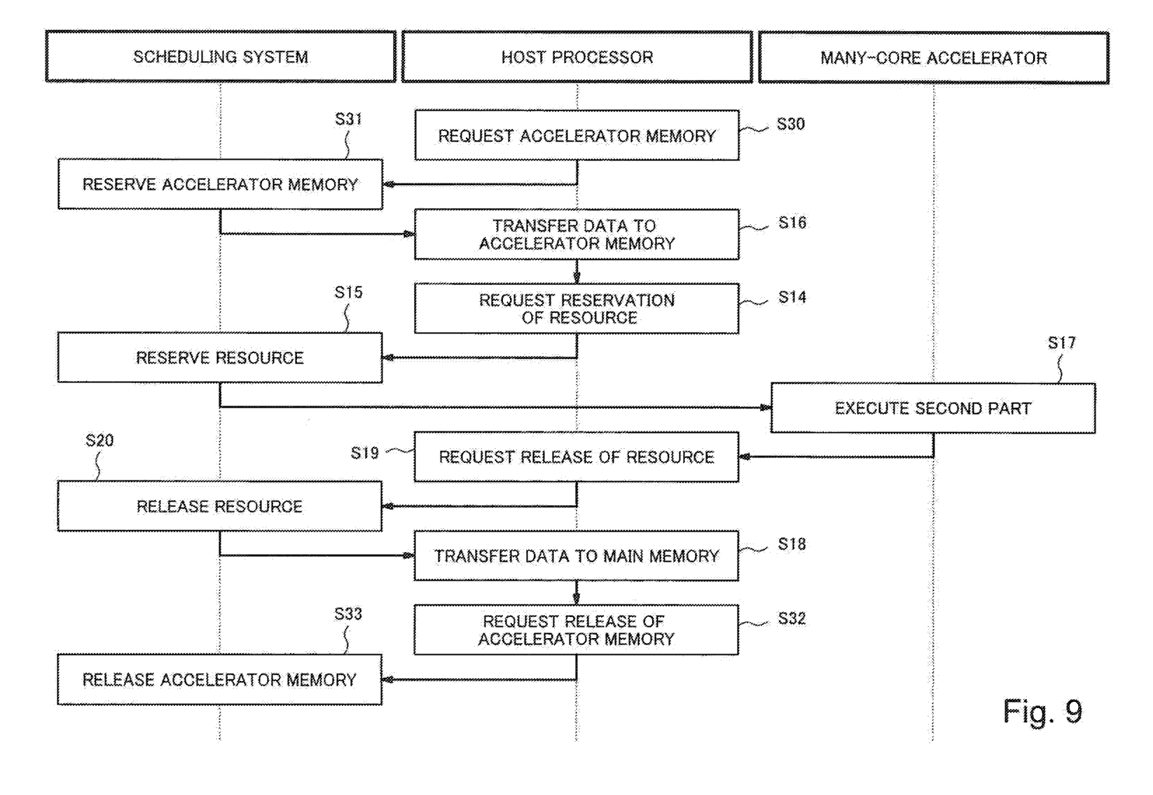

In the fourth exemplary embodiment, the scheduler 14 may reserve the accelerator memory 20 in addition to a processing apparatus in the many-core accelerator 17. In this case, a specific many-core accelerator 17 refers a specific accelerator memory 20. Referring to FIG. 9, processes executed when the scheduler 14 reserves the accelerator memory 20 will be described. FIG. 9 is a sequence diagram illustrating a second flow of processes in the scheduling system according to the fourth exemplary embodiment.

After executing the first part, the host processor 18 transmits a request for reserving a specific accelerator memory 20 to the scheduling system 13 in accordance with the first instruction (Step S30). The scheduler 14 reserves a specific accelerator memory 20 in response to receiving the request (Step S31). Then, the host processor 18 transmits data processed by the many-core accelerator 17 from the main memory 19 to the specific accelerator memory 20 (Step S16).

Next, the host processor 18 makes a request for reserving a specific resource to the scheduling system 13 (Step S14). The scheduler 14 reserves a specific resource after receiving the request (Step S15). Step S15 is a collective expression including a series of processes in Steps S2 and S3 in FIG. 2, or a series of processes in Steps S2, S3, and S6 in FIG. 4.

Next, the specific resource reserved by the scheduler 14 executes the second part (Step S17). Then, the host processor 18 transmits a request for releasing the specific resource to the scheduling system 13 in accordance with the second instruction (Step S19). Then, the scheduler 14 releases the specific resource in response to receiving the request (Step S20). Then, the host processor 18 transmits data processed by the specific resource from the accelerator memory 20 to the main memory 19 (Step S18).

Next, the host processor 18 transmits a request for releasing the specific accelerator memory 20 to the scheduler 14 (Step S32). Then, the scheduler 14 releases the specific accelerator memory 20 in response to receiving the request (Step S33).

The scheduling system 13 according to the fourth exemplary embodiment is also capable of efficiently managing data to be processed by the many-core accelerator 17 with a resource or the accelerator memory 20 in the system 57.

In other words, the scheduling system 13 according to the fourth exemplary embodiment is capable of more efficiently enabling processing performance possessed by a resource to be exhibited.

While, for convenience of description, the fourth exemplary embodiment is based on the first exemplary embodiment in the aforementioned description, the fourth exemplary embodiment may be based on the second exemplary embodiment or the third exemplary embodiment. In that case, the fourth exemplary embodiment can enjoy the similar effect to the second or third exemplary embodiment.

### Fifth Exemplary Embodiment

Next, a fifth exemplary embodiment based on the aforementioned third exemplary embodiment will be described.

In the following description, characteristic matters according to the present exemplary embodiment will be mainly described and an overlapping description of the same configuration as in the aforementioned third exemplary embodiment will be omitted by assigning the same reference sign thereto.

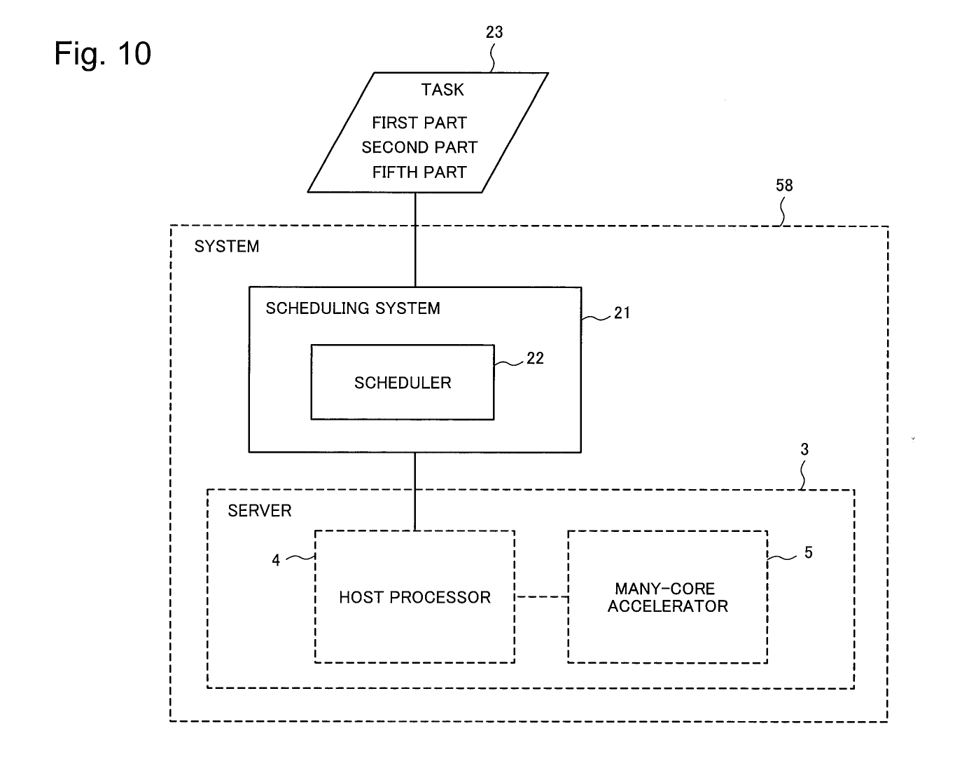

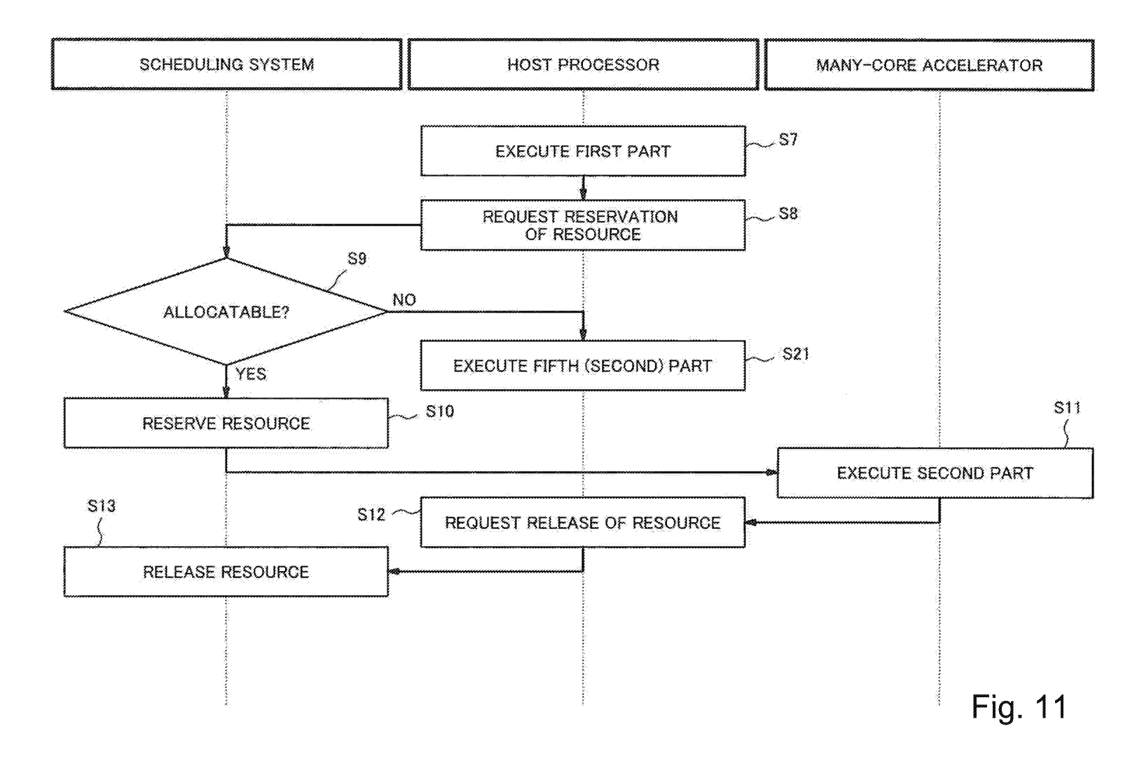

Referring to FIGS. 10 and 11, a configuration included in a scheduling system 21 according to the fifth exemplary embodiment of the present invention and processes performed by the scheduling system 21 will be described. FIG. 10 is a block diagram illustrating a configuration of the scheduling system 21 according to the fifth exemplary embodiment of the present invention. FIG. 11 is a sequence diagram illustrating a flow of processes in the scheduling system 21 according to the fifth exemplary embodiment.

Referring to FIG. 10, a system 58 includes the scheduling system 21 and the server 3 that processes a task 23. The scheduling system 21 includes a scheduler 22. The task 23 includes, in addition to a first part and a second part, a fifth part processed by a host processor 4 instead of the many-core accelerator 5 when the scheduler 22 is not able to reserve a specific resource. Processing in the fifth part is the same as processing in the second part. In other words, a result of execution of the fifth part by the host processor 4 is similar to a result of execution of the second part by a specific resource.

When the scheduler 22 decides that a resource cannot be allocated (NO in Step S9), the host processor 4 executes the fifth part (Step S21). When the scheduler 22 decides that a resource can be allocated (YES in Step S9), the scheduler 22 reserves a specific resource (Step S10).

The scheduling system 21 according to the fifth exemplary embodiment allows the host processor 4 to perform processing instead of the many-core accelerator 5 depending on resource status in the many-core accelerator 5. In other words, the task 23 can be processed more efficiently with the scheduling system 21 according to the fifth exemplary embodiment.

In other words, the scheduling system 21 according to the fifth exemplary embodiment is capable of more efficiently enabling processing performance possessed by a resource to be exhibited.

### Sixth Exemplary Embodiment

Next, a sixth exemplary embodiment based on the aforementioned first exemplary embodiment will be described.

In the following description, characteristic matters according to the present exemplary embodiment will be mainly described and an overlapping description of the same configuration as in the aforementioned first exemplary embodiment will be omitted by assigning the same reference sign thereto.

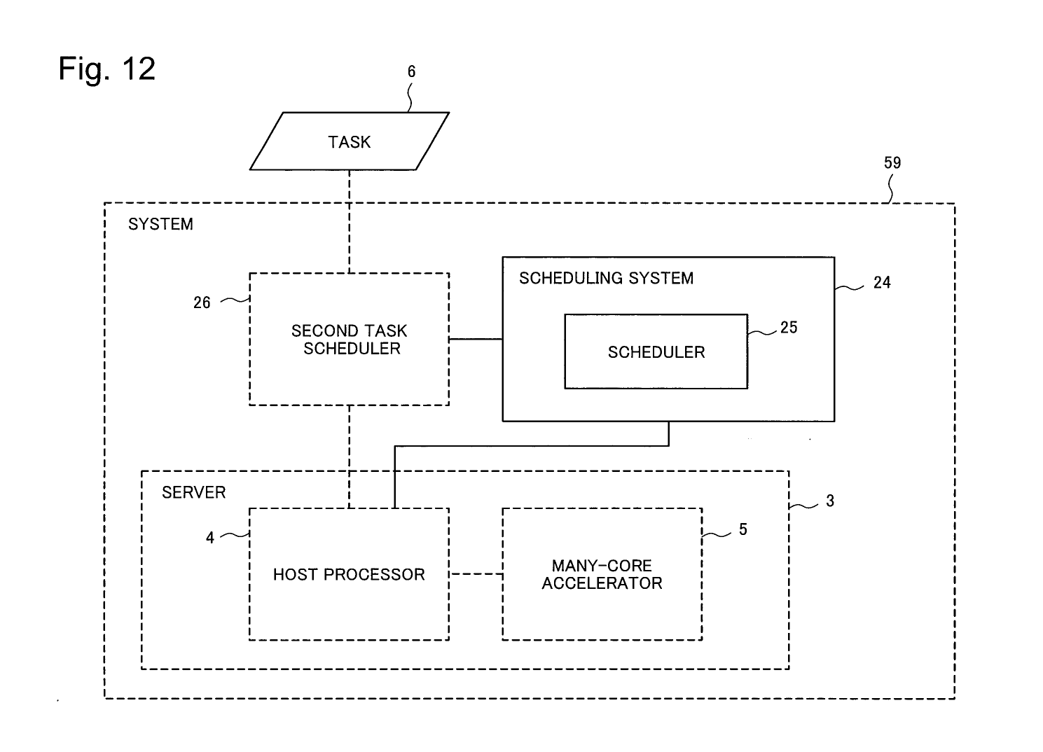

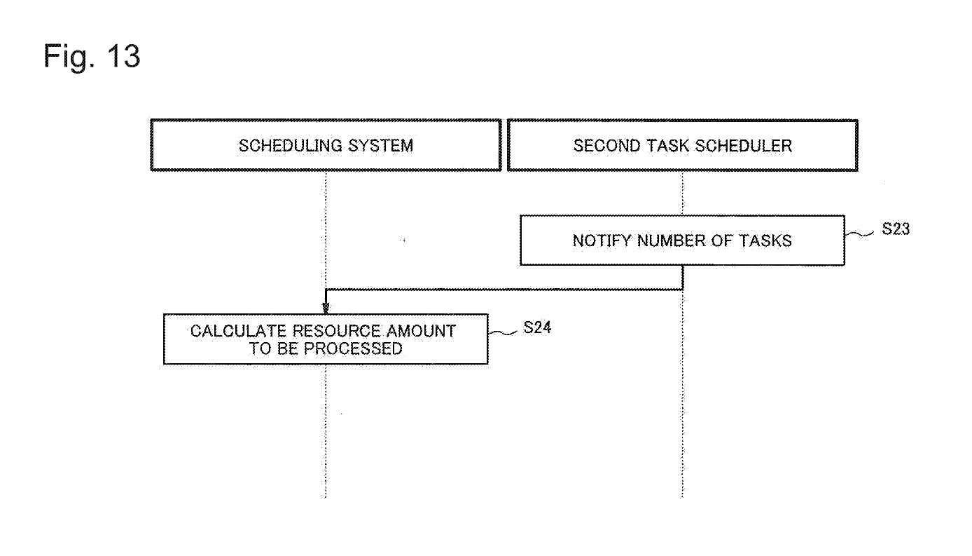

Referring to FIGS. 12 and 13, a configuration included in a scheduling system 24 according to the sixth exemplary embodiment of the present invention and processes performed by the scheduling system 24 will be described. FIG. 12 is a block diagram illustrating a configuration of the scheduling system 24 according to the sixth exemplary embodiment of the present invention. FIG. 13 is a sequence diagram illustrating a flow of processes in the scheduling system 24 according to the sixth exemplary embodiment.

Referring to FIG. 12, a system 59 includes the scheduling system 24, the server 3, and a second task scheduler 26 that controls putting a task 6 to the server 3. The scheduling system 24 includes a scheduler 25.

The second task scheduler 26 transmits, for example, information related to a task such as the number of tasks in the task 6 to the scheduling system 24 (Step S23). Then, the scheduler 25 calculates an amount of resource on the basis of the received information (Step S24). For example, the scheduler 25 may calculate an amount of resource by dividing the number of logical processors included in the many-core accelerator 5 by the number of tasks put to the server 3 by the second task scheduler 26, or may calculate an amount of resource by multiplying the amount of the value calculated above by two. A method by which the scheduling system 24 calculates an amount of resource is not limited to the aforementioned example.

The scheduling system 24 receives information usable for resource allocation control from the second task scheduler 26. Thus, the scheduling system 24 is able to perform scheduling more efficiently and adjust a load to the many-core accelerator 5.

In other words, the scheduling system 24 according to the sixth exemplary embodiment is capable of more efficiently enabling processing performance possessed by a resource to be exhibited.

### Seventh Exemplary Embodiment

Next, a seventh exemplary embodiment based on the aforementioned second exemplary embodiment will be described.

In the following description, characteristic matters according to the present exemplary embodiment will be mainly described and an overlapping description of the same configuration as in the aforementioned second exemplary embodiment will be omitted by assigning the same reference sign thereto.

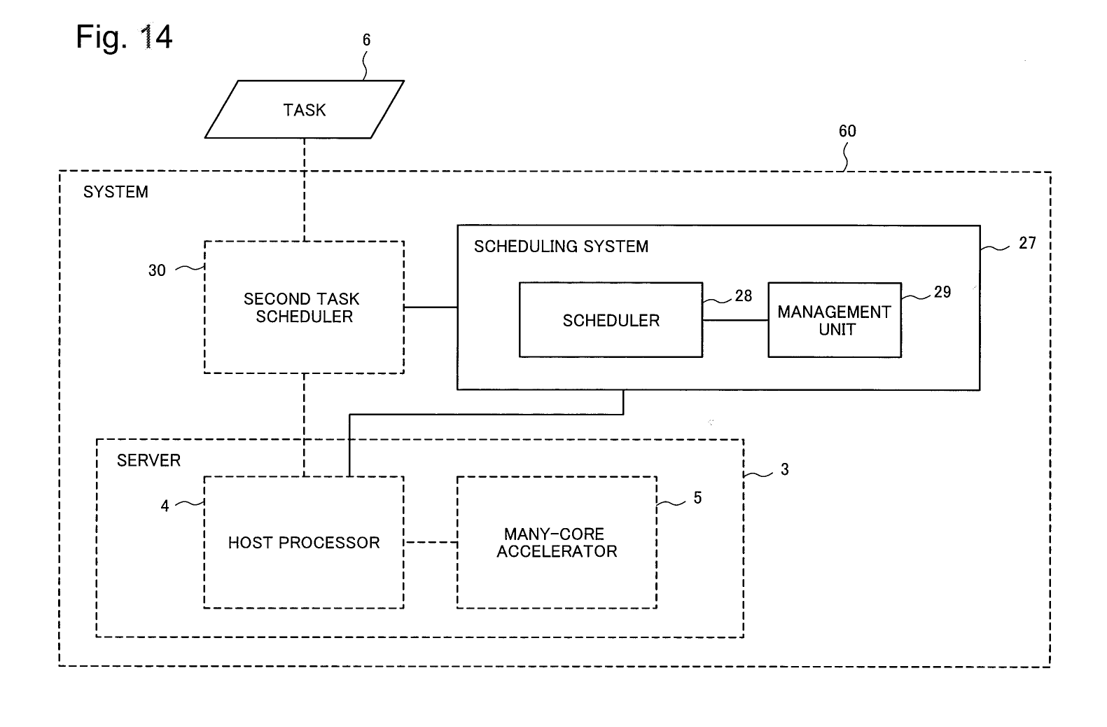

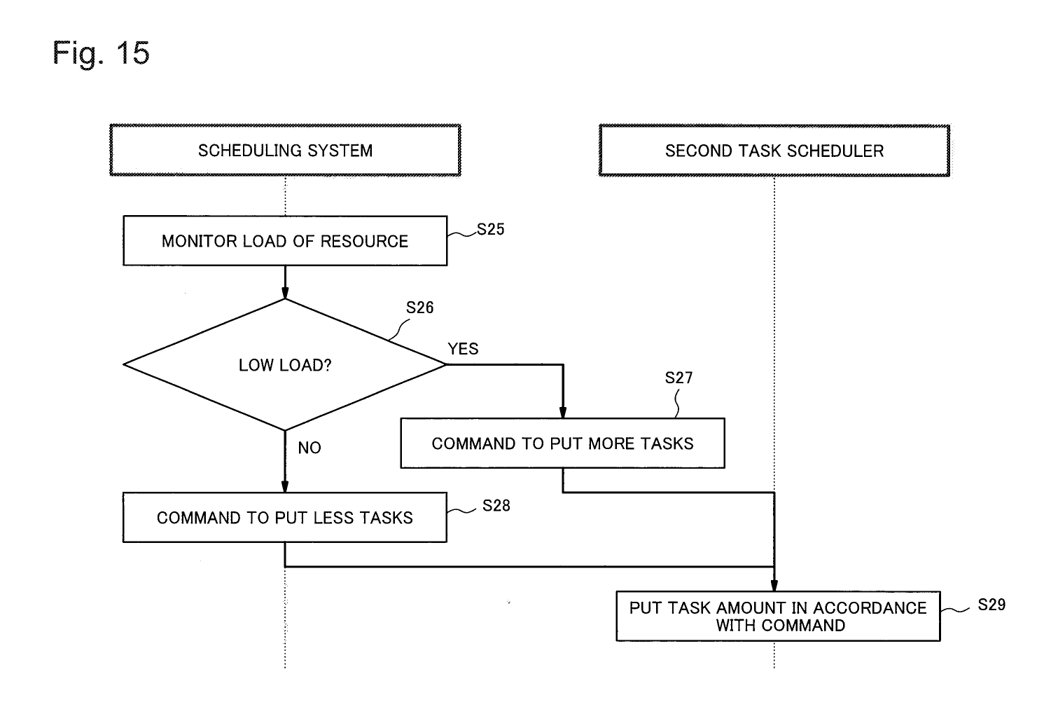

Referring to FIGS. 14 and 15, a configuration included in a scheduling system 27 according to the seventh exemplary embodiment of the present invention and processes performed by the scheduling system 27 will be described. FIG. 14 is a block diagram illustrating a configuration of the scheduling system 27 according to the seventh exemplary embodiment of the present invention. FIG. 15 is a sequence diagram illustrating a flow of processes in the scheduling system 27 according to the seventh exemplary embodiment.

Referring to FIG. 14, a system 60 includes the scheduling system 27, a second task scheduler 30, and the server 3 that processes a task 6. The scheduling system 27 includes a scheduler 28 and a management unit 29.

The scheduler 28 reads load information including a load value representing the load of a resource in the many-core accelerator 5 from the management unit 29 (Step S25). Then, the scheduler 28 compares a predetermined second threshold value with the read load value. When the read load value is decided to be less than the predetermined second threshold value, in other words, when the load status is decided to be low (YES in Step S26), the scheduler 28 transmits a signal requesting more tasks to be input to the second task scheduler 30 (Step S27). The scheduler 28 compares a predetermined first threshold value with the read load value. When the read load value is decided to be greater than the predetermined first threshold value, in other words, when the load status is decided to be high (NO in Step S26), the scheduler 28 transmits a signal requesting less tasks to be input to the second task scheduler 30 (Step S28).

Next, the second task scheduler 30 adjusts a task amount in accordance with the signal (Step S29).

Since the scheduling system 27 transmits a signal to the second task scheduler 30 regarding load information about a resource, the scheduling system 27 according to the seventh exemplary embodiment is able to adjust a load to the many-core accelerator 5 to an appropriate level.

In other words, the scheduling system 27 according to the seventh exemplary embodiment is capable of more efficiently enabling processing performance possessed by a resource to be exhibited.

### Eighth Exemplary Embodiment

Next, an eighth exemplary embodiment based on the aforementioned fourth exemplary embodiment will be described.

In the following description, characteristic matters according to the present exemplary embodiment will be mainly described and an overlapping description of the same configuration as in the aforementioned fourth exemplary embodiment will be omitted by assigning the same reference sign thereto.

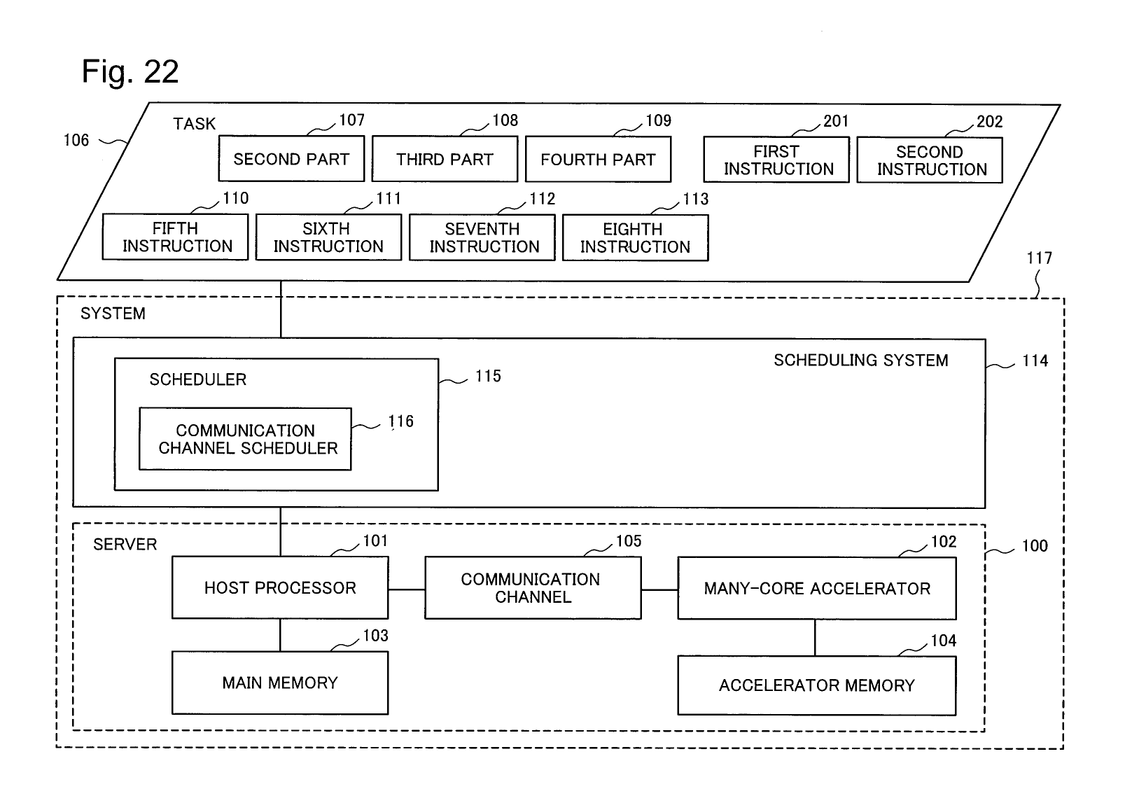

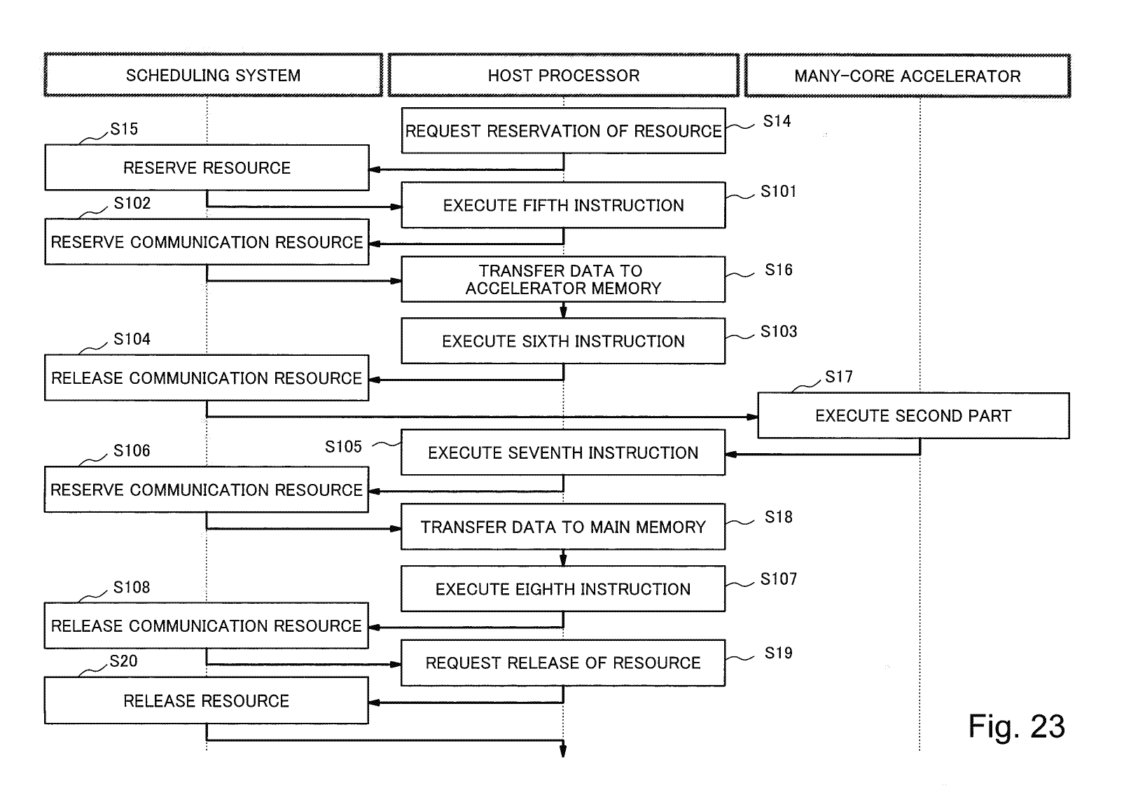

Referring to FIGS. 22 and 23, a configuration included in a scheduling system 114 according to the eighth exemplary embodiment of the present invention and processes performed by the scheduling system 114 will be described. FIG. 22 is a block diagram illustrating a configuration of the scheduling system 114 according to the eighth exemplary embodiment of the present invention. FIG. 23 is a sequence diagram illustrating a flow of processes in the scheduling system 114 according to eighth exemplary embodiment.

A system 117 includes a server 100 and the scheduling system 114.

The server 100 includes a host processor 101, a main memory 103, a many-core accelerator 102, an accelerator memory 104, and a communication channel 105 that connects the host processor 101 and the many-core accelerator 102. The host processor 101 and the many-core accelerator 102 communicate (also referred to as access or transmit/receive) data to be referenced via the communication channel 105.

The scheduling system 114 includes a scheduler 115 and a communication channel scheduler 116 that reserves a communication resource included in the communication channel 105.

First, the host processor 101 sends a first instruction 201 that reserves a resource in the many-core accelerator 102 to the scheduling system 114 (Step S14). The scheduling system 114 reserves a specific resource in the many-core accelerator 102 in accordance with the first instruction 201 (Step S15). Then, the host processor 101 receives a fifth instruction 110 for reserving the communication channel 105. The fifth instruction 110 is included in a task 106. In accordance with the received fifth instruction 110, the host processor 101 commands the communication channel scheduler 116 to reserve a communication resource included in the communication channel 105 (Step S101).

Next, the communication channel scheduler 116 receives a command for reserving a communication resource capable of communicating traffic based on the fifth instruction 110 from the host processor 101. The communication channel scheduler 116 measures traffic on the communication channel 105 until the communication channel 105 becomes capable of communicating traffic based on the fifth instruction 110. When the communication channel 105 is capable of communicating traffic based on the fifth instruction 110, the communication channel scheduler 116 reserves a communication resource based on the fifth instruction 110 from the communication channel 105 (Step S102).

Next, the host processor 101 transmits data accessed by the many-core accelerator 102 from the main memory 103 to the accelerator memory 104 via the communication resource reserved by the communication channel scheduler 116 (Step S16).

In other words, the host processor 101 transmits data from the main memory 103 to the accelerator memory 104. Then, the host processor 101 transmits a request for releasing the reserved communication resource to the communication channel scheduler 116 in accordance with a sixth instruction 111 for releasing the reserved communication resource (Step S103).

The communication channel scheduler 116 receives a request for releasing the reserved communication resource and releases the reserved communication resource in accordance with the received request (Step S104).

Next, a specific resource reserved by the scheduler 115 executes a second part 107 in the task 106 by accessing data stored in the accelerator memory 104 (Step S17).

The host processor 101 transmits a request for reserving a communication resource capable of communicating traffic based on the seventh instruction 112 to the communication channel scheduler 116 in accordance with a seventh instruction 112 for reserving a communication resource included in the communication channel 105 (Step S105).

The communication channel scheduler 116 receives a command for reserving a communication resource from the host processor 101. Then, the communication channel scheduler 116 measures traffic on the communication channel 105 until a communication resource capable of communicating traffic designated by the seventh instruction 112 can be reserved. When the communication channel 105 is capable of communicating traffic based on the seventh instruction 112, the communication channel scheduler 116 reserves a communication resource based on the seventh instruction 112 from the communication channel 105 (Step S106).

The host processor 101 transmits data processed by the specific resource, etc. from the accelerator memory 104 to the main memory 103 via the communication resource reserved by the communication channel scheduler 116 (Step S18).

The host processor 101 receives an eighth instruction 113 for releasing the reserved communication resource from the task 106. In accordance with the received eighth instruction 113, the host processor 101 transmits a command for releasing the reserved communication resource to the communication channel scheduler 116 (Step S107).

The communication channel scheduler 116 receives the command from the host processor 101 and releases the reserved communication resource in accordance with the received command (Step S108).

In accordance with the aforementioned second instruction 202, the host processor 101 transmits a command for releasing the specific resource to the scheduling system 114 (Step S19).

The scheduling system 114 receives the command from the host processor 101 and releases the reserved specific resource in accordance with the received command (Step S20).

In the aforementioned example, it was assumed that the fifth instruction 110, the sixth instruction 111, the seventh instruction 112, and the eighth instruction 113 were described to represent instructions for reserving a communication resource or instructions for releasing a communication resource. However, the instructions may include other information. For example, the fifth instruction to the eighth instruction may include information identifying a task 106 issuing the instruction or may include time of receipt of the instruction. In addition, the fifth instruction to the eighth instruction may include a size of data transmitted/received between the main memory 103 and the accelerator memory 104 or may include information about a data structure in the main memory 103, or the like.

In the aforementioned example, it was assumed that the fifth instruction 110 and the seventh instruction 112 were described to be different instructions. However, the instructions may be a same instruction. Similarly, in the aforementioned example, it was assumed that the sixth instruction 111 and the eighth instruction 113 were described to be different instructions. However, the instructions may be a same instruction. In this case, the task 106 executes the fifth instruction 110 instead of the seventh instruction 112 and executes the eighth instruction 113 instead of the sixth instruction 111.

In the case of the aforementioned example, the communication channel scheduler 116, for example, reserves, in accordance with the seventh instruction 112, a process related to the fifth instruction 110, specifically, a communication resource. Similarly, the communication channel scheduler 116 releases a process related to the sixth instruction 111, specifically, a communication resource in accordance with the eighth instruction 113.

In addition, a third part 108 may include a process that reserves a storage area in the accelerator memory 104. Similarly, a fourth part 109 may include a process that releases a storage area in the accelerator memory 104.

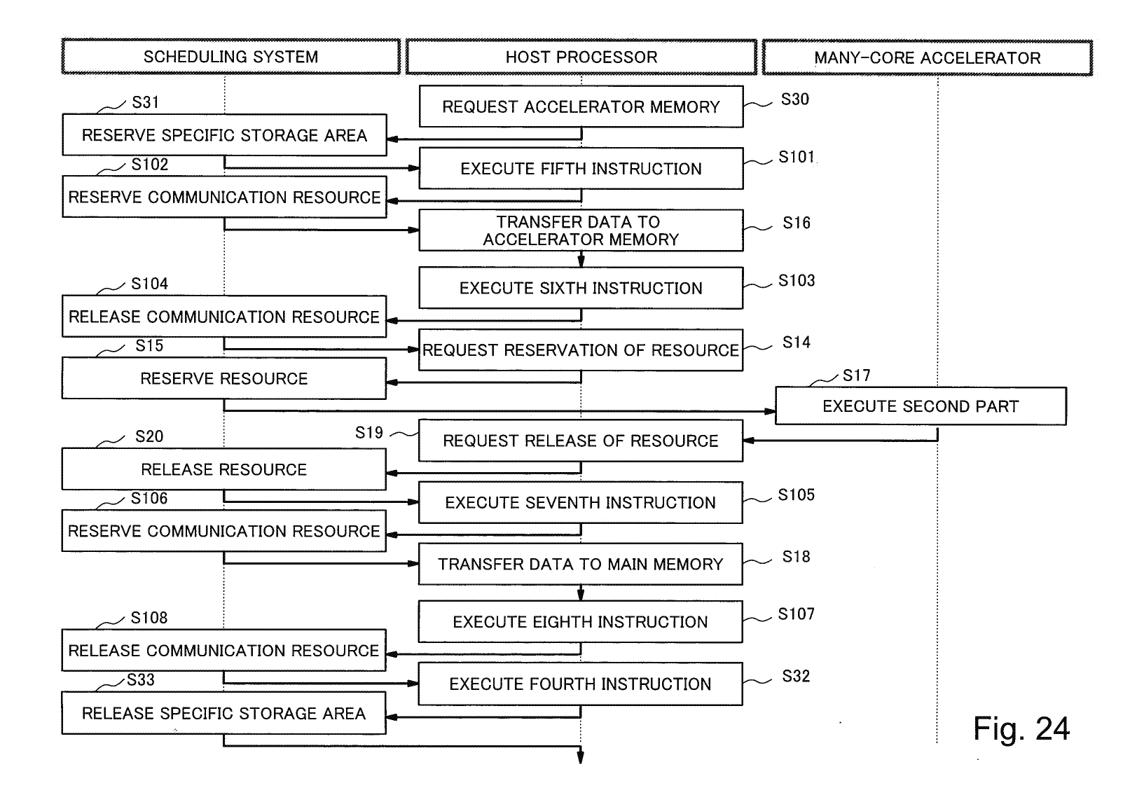

Further, in the present exemplary embodiment, the scheduler 115 may reserve a storage area in the accelerator memory 104. In this case, the scheduling system 114 performs processes illustrated in FIG. 24. FIG. 24 is a sequence diagram illustrating a flow of processes executed by the scheduling system 114 when the scheduler reserves a storage area in the accelerator memory in the eighth exemplary embodiment.

First, the host processor 101 transmits a command for reserving a certain size of a storage area in the accelerator memory 104 to the scheduling system 114 (Step S30). Then, the scheduler 115 receives the command from the host processor 101 and reserves a certain size of a storage area in the accelerator memory 104 in accordance with the received command (Step S31).

Next, the host processor 101 receives the fifth instruction 110 for reserving the communication channel 105 in the task 106 and transmits a command for reserving a communication resource included in the communication channel 105 to the communication channel scheduler 116 in accordance with the received fifth instruction 110 (Step S101).

Next, the communication channel scheduler 116 receives the command for reserving a communication resource based on the fifth instruction 110 from the host processor 101. The communication channel scheduler 116 measures traffic (hereinafter “communication band” is used as a synonym) transmitted/received on the communication channel 105 until the communication channel 105 becomes capable of communicating traffic based on the fifth instruction 110. When the communication channel 105 is capable of communicating traffic based on the fifth instruction 110, the communication channel scheduler 116 reserves a communication resource based on the fifth instruction 110 (Step S102).

Next, the host processor 101 transmits data processed by the many-core accelerator 102 from the main memory 103 to a specific storage area in the accelerator memory 104 via the communication resource reserved by the communication channel scheduler 116 (Step S16).

The host processor 101 transmits a command for releasing the reserved communication resource to the communication channel scheduler 116 in accordance with the sixth instruction 111 that releases the reserved communication resource (Step S103).

The communication channel scheduler 116 receives the command for releasing the reserved communication resource and releases the reserved communication resource in accordance with the received command (Step S104).

Next, the host processor 101 transmits a command for reserving a resource to the scheduling system 114 in accordance with the first instruction 201 that reserves a resource in the many-core accelerator 102 (Step S14). The scheduler 14 reserves a specific resource in the many-core accelerator 102 in response to receiving the command (Step S15).

The specific resource reserved by the scheduler executes the second part 107 in the task 106 by processing data transmitted to the accelerator memory 104 (Step S17).

After the specific resource completes processing in the second part 107, the host processor 101 commands the scheduling system 114 to release the specific resource in accordance with the second instruction 202 that releases the reserved resource (Step S19). Then, the scheduler 14 releases the specific resource in accordance with the command (Step S20).

In the task 106, the host processor 101 transmits a command for reserving a communication resource based on the seventh instruction 112 to the communication channel scheduler 116 in accordance with the seventh instruction 112 that reserves a communication resource included in the communication channel 105 (Step S105).

The communication channel scheduler 116 receives a command for reserving a communication resource from the host processor 101. Then, the communication channel scheduler 116 measures traffic transmitted/received on the communication channel 105 until the communication channel 105 becomes capable of communicating traffic based on the seventh instruction 112. When the communication channel 105 is capable of communicating traffic based on the seventh instruction 112, the communication channel scheduler 116 reserves a communication resource based on the seventh instruction 112 (Step S106).

The host processor 101 transmits data processed by the specific resource, etc. from the accelerator memory 104 to the main memory 103 via the communication resource reserved by the communication channel scheduler 116 (Step S18).

The host processor 101 receives the eighth instruction 113 for releasing the reserved communication resource from the task 106 and commands the communication channel scheduler 116 to release the reserved communication resource in accordance with the received eighth instruction 113 (Step S107).

The communication channel scheduler 116 receives the command from the host processor 101 and releases the reserved communication resource in accordance with the received command (Step S108).

The host processor 101 transmits a command for releasing the reserved specific storage area to the scheduler (Step S32). Then, the scheduler 14 releases the reserved specific storage area in response to receiving the command (Step S33).

Since the eighth exemplary embodiment includes a similar configuration to the fourth exemplary embodiment, the eighth exemplary embodiment can enjoy the similar effect to the fourth exemplary embodiment. In other words, the scheduling system 114 according to the eighth exemplary embodiment is capable of more efficiently enabling processing performance possessed by a resource to be exhibited.

In the present exemplary embodiment, the communication channel scheduler 116 reserves a communication resource in accordance with an instruction in the task 106. The host processor 101 and the many-core accelerator 102 transmit/receive data between the main memory 103 and the accelerator memory 104 via the communication resource. Therefore, the present exemplary embodiment reduces possibility of communication delay on the communication channel 105. Further, when the communication channel scheduler 116 is not able to reserve an amount of a communication resource capable of transmitting/receiving data based on an instruction in the task 106, data transmission/reception required for processing the task 106 is temporarily halted in advance. Consequently, according to the present exemplary embodiment, possibility of data transmission/reception for a task other than the task being interfered is low.

In other words, according to the present exemplary embodiment, the communication channel scheduler 116 controls communication transmitted/received between the main memory 103 and the accelerator memory 104 based on communication performance of the communication channel 105. Therefore, an amount of data to be transmitted between the main memory 103 and the accelerator memory 104 per unit time is less than an amount of transmission that can be transmitted per unit time on the communication channel. Therefore, possibility of delay in processing in the many-core accelerator 102 due to communication delay on the communication channel 105 is low. Consequently, the present exemplary embodiment is capable of more efficiently enabling processing performance possessed by a resource to be exhibited.

In the present exemplary embodiment, it was assumed that the scheduler 115 was described to include the communication channel scheduler 116 for convenience of description. However, the scheduler 115 may realize a function in the communication channel scheduler 116.

### Ninth Exemplary Embodiment

Next, a ninth exemplary embodiment based on the aforementioned eighth exemplary embodiment will be described.

In the following description, characteristic matters according to the present exemplary embodiment will be mainly described and an overlapping description of the same configuration as in the aforementioned eighth exemplary embodiment will be omitted by assigning the same reference sign thereto.

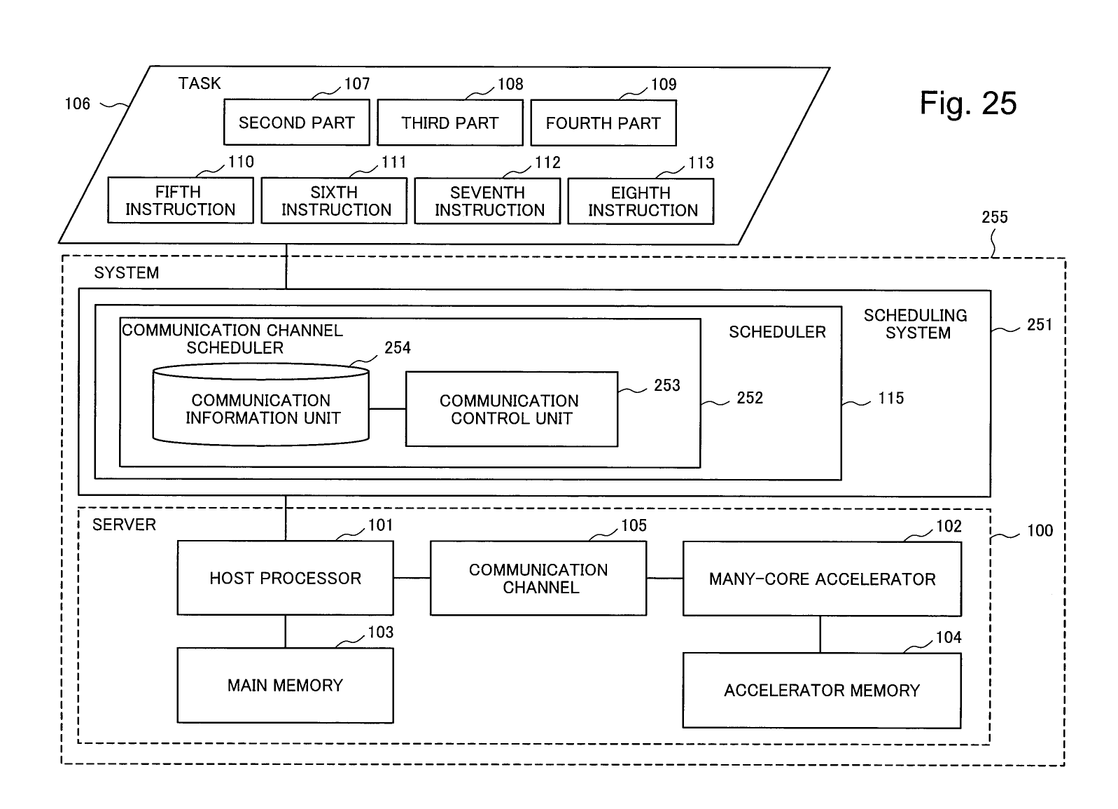

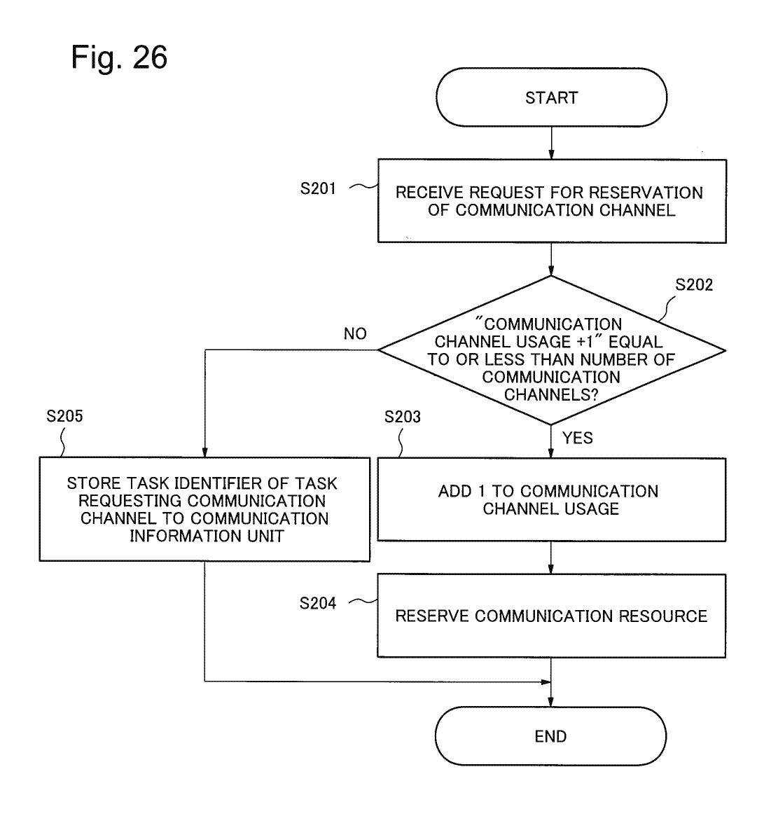

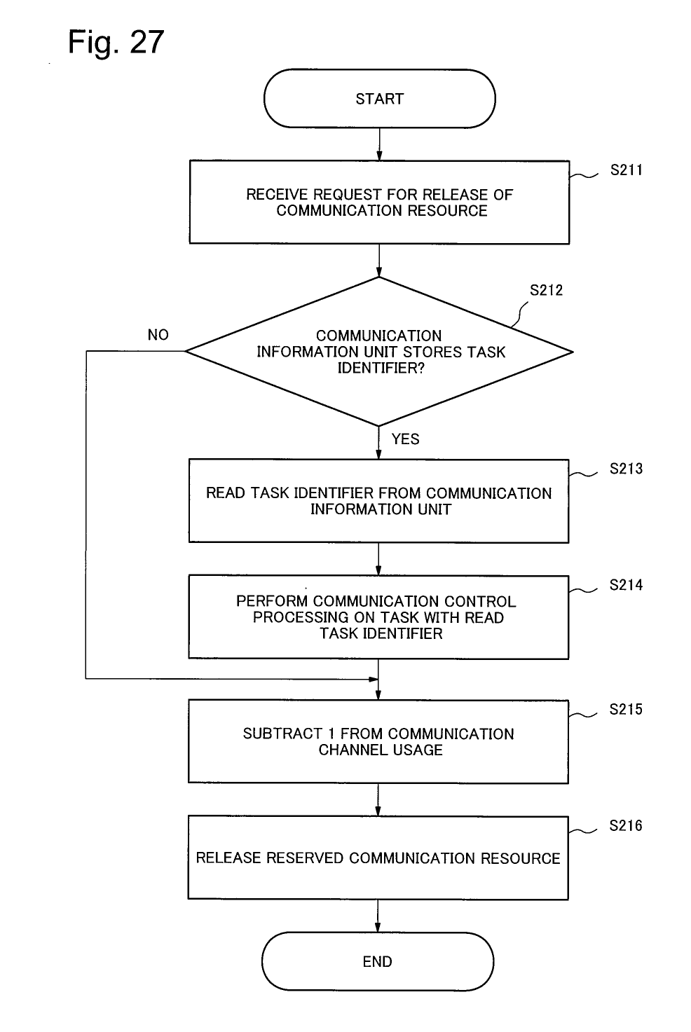

Referring to FIGS. 25 to 27, a configuration included in a scheduling system 251 according to the ninth exemplary embodiment of the present invention and processes performed by the scheduling system 251 will be described. FIG. 25 is a block diagram illustrating a configuration of the scheduling system 251 according to the ninth exemplary embodiment of the present invention. FIG. 26 is a flowchart illustrating a flow of processes when receiving a fifth instruction 110 or a seventh instruction 112 in the scheduling system 251 according to the ninth exemplary embodiment. FIG. 27 is a flowchart illustrating a flow of processes when receiving a sixth instruction 111 or an eighth instruction 113 in the scheduling system 251 according to the ninth exemplary embodiment.

A system 255 includes a server 100 and the scheduling system 251.

The scheduling system 251 includes a scheduler 115 and a communication channel scheduler 252. Further, the communication channel scheduler 252 includes a communication information unit 254 and a communication control unit 253.

First, a host processor 101 transmits a command for reserving a communication resource to the communication channel scheduler 252 in accordance with the fifth instruction 110 in Step S101 or the seventh instruction 112 in Step S105.

Next, the communication channel scheduler 252 receives a command for reserving a communication resource from the host processor 101 (Step S201). Then, the communication control unit 253 in the communication channel scheduler 252 examines whether or not a communication channel 105 includes a communication channel in an unused (also referred to as “dormant,” “idle,” “standby,” etc.) state. An “unused state” represents a state in which a target apparatus is not assigned to a task, etc.

For example, the communication control unit 253 examines whether or not the communication channel 105 includes a communication channel in an unused state on the basis of a communication channel usage representing the total number of communication channels used by a task. In accordance with the received command, the communication control unit 253 compares a calculated value obtained by adding 1 to the communication channel usage with the number of communication channels originally included in the communication channel 105 in accordance with the received command (Step S202).

When the calculated communication channel usage is equal to or less than the number of communication channels included in the communication channel 105 (YES in Step S202), the communication control unit 253 updates the communication channel usage to the calculated value (Step S203).

The communication channel scheduler 252 reserves a communication resource from a communication channel in an unused state in accordance with the received command (Step S204).

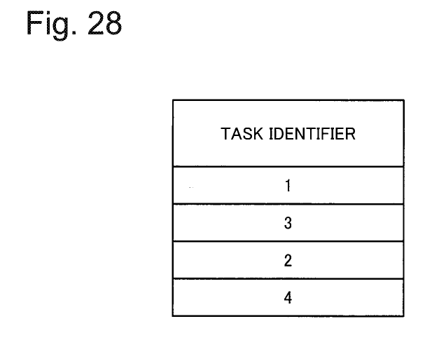

When the calculated communication channel usage is greater than the number of communication channels included in the communication channel 105 (NO in Step S202), the communication control unit 253 stores a task identifier into the communication information unit 254 (Step S205). In other words, as illustrated in FIG. 28, the communication control unit 253 stores a task identifier associated with a task 106 that executes the fifth instruction 110 or the seventh instruction 112, either of the instructions activating the received command, into the communication information unit 254 (Step S205). A task identifier represents an identifier capable of uniquely identifying a task. FIG. 28 is a conceptual diagram illustrating an example of a task identifier that can be stored in the communication information unit 254.

For example, the communication information unit 254 stores a task identifier “1,” a task identifier “3,” a task identifier “4,” and a task identifier “2.” In this case, the communication channel scheduler 252 does not reserve a communication resource for tasks with the task identifier “1,” the task identifier “3,” the task identifier “4,” and the task identifier “2” in the process in Step S205.

Next, processes performed when the host processor 101 commands the communication channel scheduler 252 to release a reserved communication resource in accordance with the sixth instruction 111 in Step S103 or the eighth instruction 113 in Step S107 will be described.

First, the host processor 101 receives a sixth instruction 111 or an eighth instruction 113 from the task 106. Then, the host processor 101 transmits a command for releasing a reserved communication resource to the communication channel scheduler 252 in accordance with the received sixth instruction 111 or the eighth instruction 113. Then, the communication channel scheduler 252 receives a command for releasing the reserved communication resource from the host processor 101 (Step S211).

Next, the communication control unit 253 in the communication channel scheduler 252 decides whether or not the communication information unit 254 stores a task identifier (Step S212). When the communication information unit 254 is decided to store a task identifier (YES in Step S212), the communication control unit 253 reads a specific task identifier from the communication information unit 254 (Step S213). Then, the communication control unit 253 controls communication for the task represented by the read task identifier as illustrated in Steps S202 to S205 in FIG. 26 (Step S214).

Next, the communication channel scheduler 252 subtracts 1 from the communication channel usage and sets the communication channel usage to the calculated value (Step S215). The communication channel scheduler 252 releases the reserved communication resource in accordance with the command for releasing a communication resource (Step S216). The communication channel scheduler 252 may process Step S216 prior to Step S215.

In the aforementioned example, a function implemented by use of the communication channel usage may be implemented with a similar value such as the number of communication channels in an unused state.

Further, the communication information unit 254 may include a queue structure capable of storing task identifiers. In other words, the communication information unit 254 may include a data structure capable of storing task identifiers in order of time of receipt and outputting the stored task identifiers in order of time of receipt. In this case, the communication control unit 253 performs the processes illustrated in Step S212 or later, in order of time of receiving a command for reserving a communication resource.

Since the ninth exemplary embodiment includes a similar configuration to the eighth exemplary embodiment, the ninth exemplary embodiment can enjoy the similar effect to the eighth exemplary embodiment. In other words, the scheduling system 251 according to the ninth exemplary embodiment is capable of more efficiently enabling processing performance possessed by a resource to be exhibited.

Further, the communication channel scheduler 252 allocates a communication resource to a task 106, to which a communication resource is not allocatable in response to a command for reserving the communication channel 105, depending on a process of releasing a communication resource for another task. Therefore, the present exemplary embodiment provides more efficient allocation of a communication resource. Consequently, more efficient access is provided between the accelerator memory 104 and the main memory 103. In other words, the scheduling system 251 according to the ninth exemplary embodiment provides further reduction of processing performance degradation.

In the aforementioned example, it was assumed that the communication channel scheduler 252 managed a communication resource in the communication channel 105 based on a communication channel usage. However, the communication channel scheduler 252 may manage a communication resource by a communication channel measurement function that measures a communication band used in the communication channel 105.

In this example, the communication channel scheduler 252 compares a communication band measured by the communication channel measurement function with an available communication band in the communication channel 105. When the measured communication band is less than the available communication band, the communication channel scheduler 252 reserves a communication resource in accordance with a request for reserving the communication channel 105 (Step S204 in FIG. 26). On the other hand, when the measured communication band is greater than the available communication band, the communication channel scheduler 252 stores the task identifier of the task 106 requesting the communication channel 105 into the communication information unit 254 (Step S205 in FIG. 26).

### Tenth Exemplary Embodiment

Next, a tenth exemplary embodiment based on the aforementioned ninth exemplary embodiment will be described.

In the following description, characteristic matters according to the present exemplary embodiment will be mainly described and an overlapping description of the same configuration as in the aforementioned ninth exemplary embodiment will be omitted by assigning the same reference sign thereto.

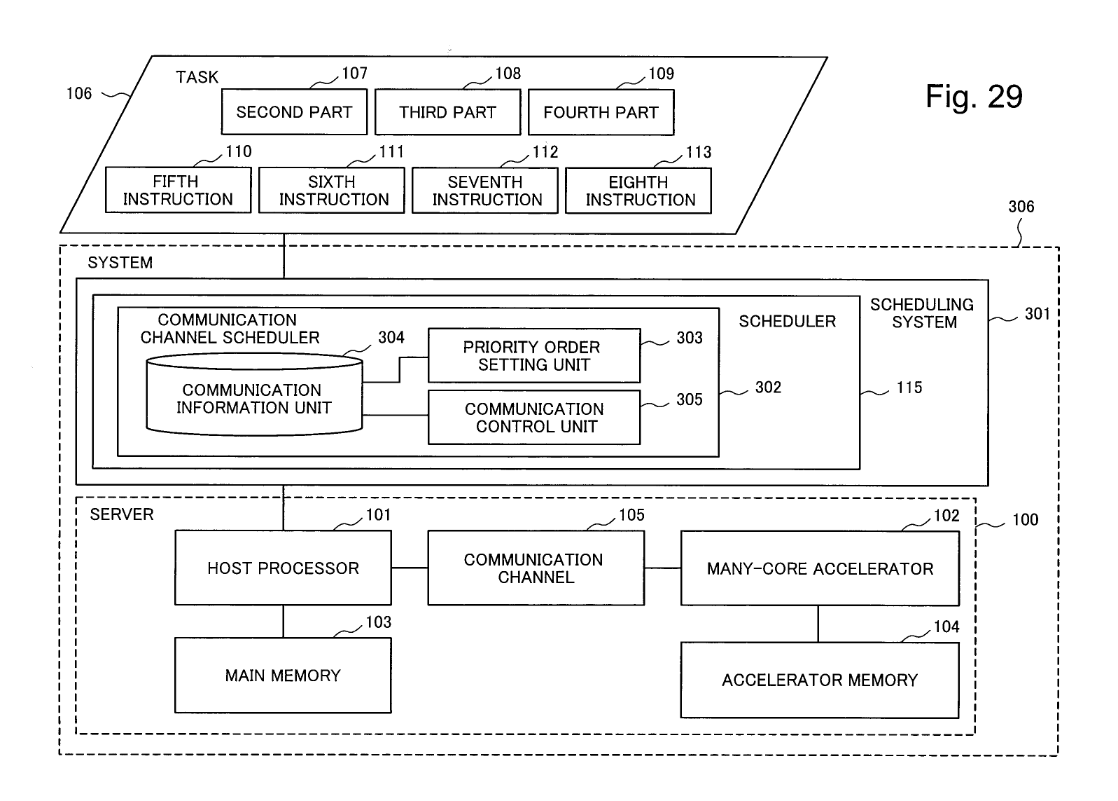

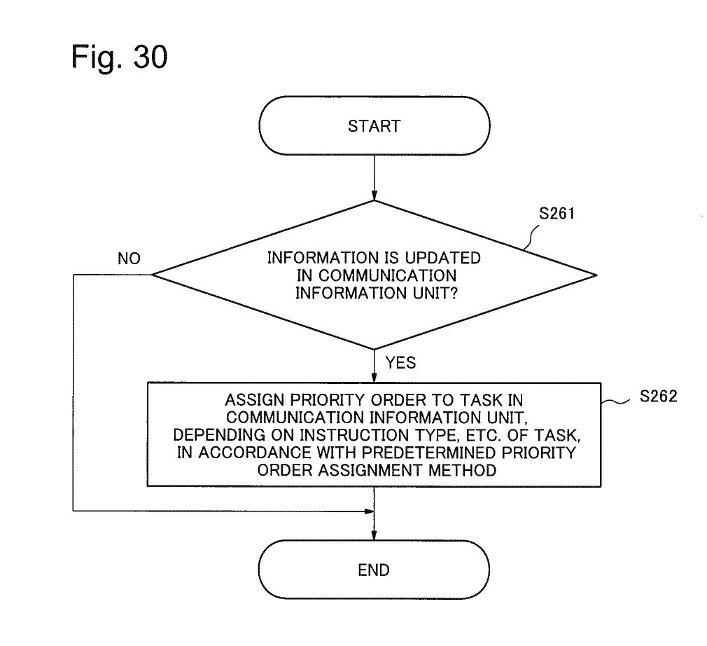

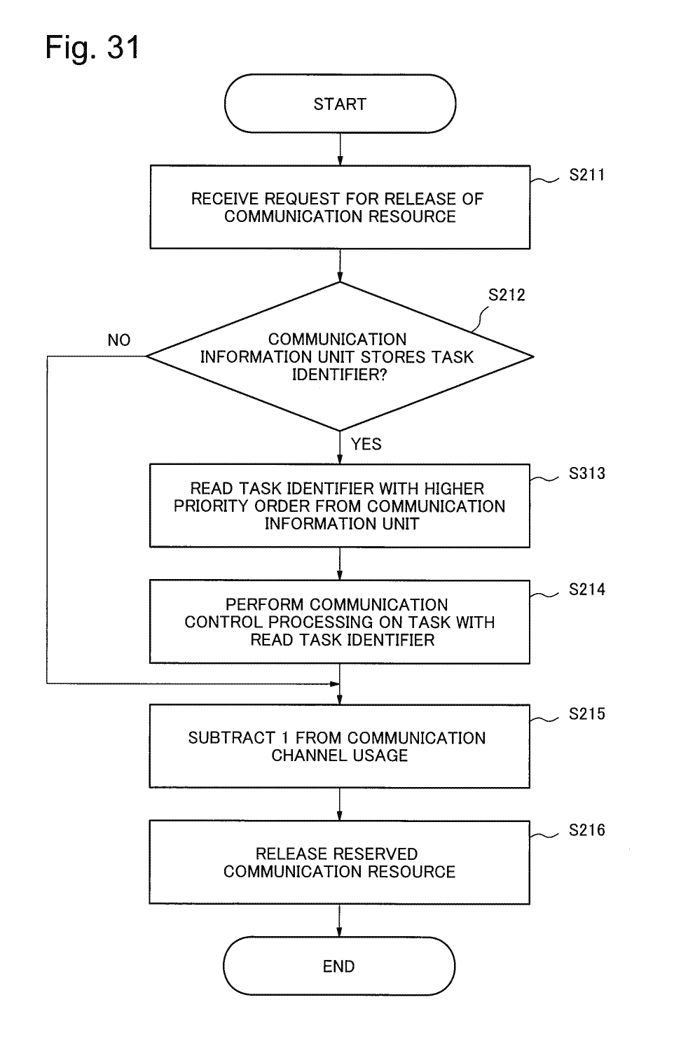

Referring to FIGS. 29 to 31, a configuration included in a scheduling system 301 according to the tenth exemplary embodiment of the present invention and processes performed by the scheduling system 301 will be described. FIG. 29 is a block diagram illustrating a configuration of the scheduling system 301 according to the tenth exemplary embodiment of the present invention. FIG. 30 is a flowchart illustrating a flow of processes in a priority order setting unit 303 according to the tenth exemplary embodiment. FIG. 31 is a flowchart illustrating a flow of processes in a communication control unit 305 according to the tenth exemplary embodiment.

A system 306 includes a server 100 and the scheduling system 301.

The scheduling system 301 includes a scheduler 115 and a communication channel scheduler 302. The communication channel scheduler 302 includes the communication control unit 305, a communication information unit 304, and the priority order setting unit 303.

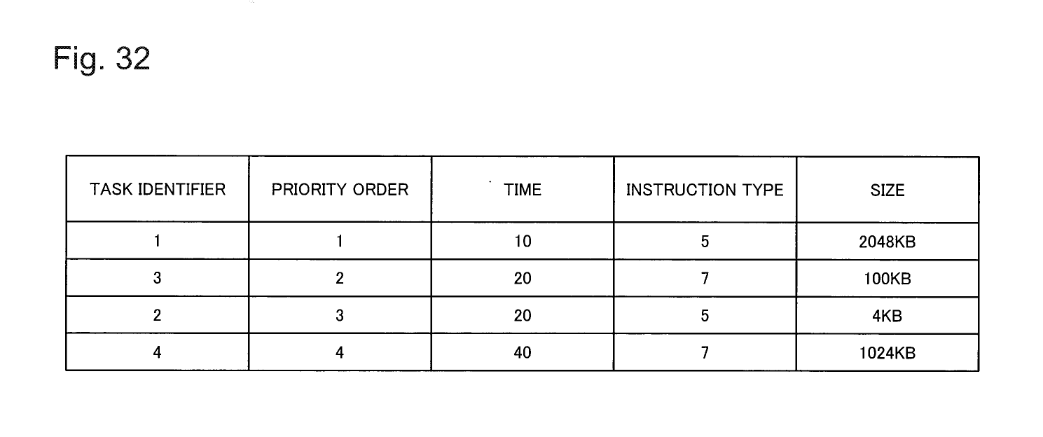

The communication information unit 304 is able to store, as illustrated in FIG. 32, a task identifier in association with a priority order representing an order of processing of a task 106 associated with the task identifier. FIG. 32 is a conceptual diagram illustrating information that can be stored in the communication information unit 304 according to the tenth exemplary embodiment. For example, the communication information unit 304 may further store time of receiving a communication resource from the task 106 and a type of instruction received from the task 106 (representing, for example, a fifth instruction 110, a seventh instruction 112, or the like) being associated therewith. Further, the communication information unit 304 may store a size of data transmitted/received via a communication resource, etc. being associated therewith.

For example, the first row in FIG. 32 (hereinafter referred to as “first data”) represents that a task with a task identifier “1” requests a communication resource for transmitting/receiving data with a size of 2048 kilobytes (hereinafter abbreviated as “KB”) at time “10” by the fifth instruction 110. Similarly, the second row in FIG. 32 (hereinafter referred to as “second data”) represents that a task with a task identifier “3” requests a communication resource for transmitting/receiving data with a size of 100 KB at time “20” by the seventh instruction 112.

The first data and the second data are respectively associated with a priority order “1” and a priority order “2”. Since the priority order of the first data is smaller than the priority order of the second data, the communication control unit 305 processes the first data prior to the second data.

The priority order setting unit 303 decides whether or not data stored in the communication information unit 304 are updated (Step S261). For example, when the communication control unit 305 updates a value in the communication information unit 304 in accordance with the fifth instruction 110 or the seventh instruction 112, the priority order setting unit 303 decides that data stored in the communication information unit 304 are updated.

When data stored in the communication information unit 304 are decided to be updated (YES in Step S261), the communication control unit 305 assigns the aforementioned priority order to the task 106 depending on the instruction type, etc. of the task 106 (Step S262). In this case, the communication control unit 305 assigns a priority order in accordance with a predetermined priority order assignment method. Further, when data stored in the communication information unit 304 are decided not to be updated (NO in Step S261), the communication control unit 305 does not perform the aforementioned process.

For example, as a predetermined priority order assignment method, there is a method in which a task with an instruction type “5” is assigned a higher priority order than a task with an instruction type “7”. In this case, the communication control unit 305 processes a task with the instruction type “5” in preference to a task with the instruction type “7”. The instruction type “7” represents the seventh instruction. Similarly, the instruction type “5” represents the fifth instruction.

The communication control unit 305 receives a command for releasing a reserved communication resource from the host processor 101 in accordance with a sixth instruction 111 or an eighth instruction 113 (Step S211). Then, the communication control unit 305 reads whether or not the communication information unit 304 stores a task identifier (Step S212). When the communication information unit 304 is decided not to store a task identifier (NO in Step S212), the communication control unit 305 releases the reserved communication resource (Step S216).

For example, when a communication resource in the communication channel 105 is managed based on a communication channel usage as the aforementioned example, the communication control unit 305 may calculate a value by subtracting 1 from the communication channel usage and update the communication channel usage with the calculated value (Step S215).

On the other hand, when the communication information unit 304 is decided to store a task identifier (YES in Step S212), the communication control unit 305 reads a task identifier associated with a high priority order from the communication information unit 304 (Step S313). For example, the communication control unit 305 may read a task identifier with the highest priority order in the communication information unit 304. Then, the communication control unit 305 performs processes such as reservation of a communication resource as illustrated in FIG. 26 on a task associated with the read task identifier (Step S214). Then, the communication control unit 305 releases a communication resource being a target of the release in accordance with the received command (Step S216).

Similar to the aforementioned processes, the communication control unit 305 may calculate a value by subtracting 1 from a communication channel usage and update the communication channel usage with the calculated value (Step S215).

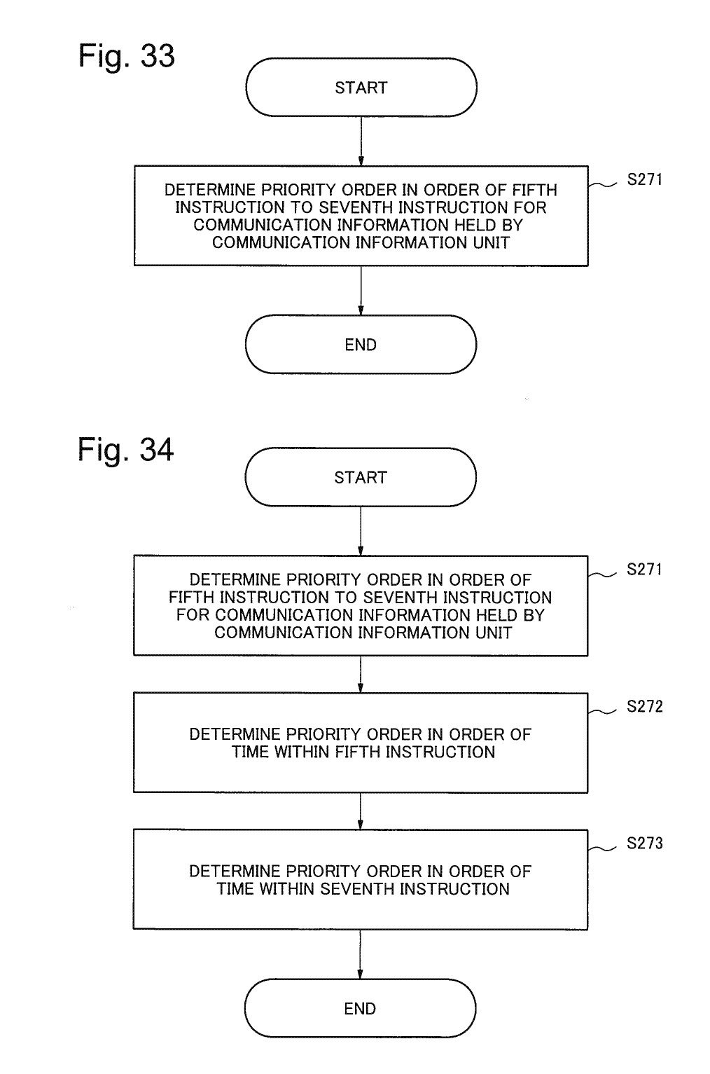

A predetermined priority order assignment method includes, for example, assignment methods illustrated in FIGS. 33 to 36. Each of FIGS. 33 to 36 is a flowchart illustrating an example of a flow of processes in a predetermined priority order assignment method according to the tenth exemplary embodiment.

For example, a task with an instruction type “5” associated with the task identifier is assigned a higher priority order than a task with an instruction type “7” in an examples (FIG. 33) of tasks stored in the communication information unit 304 (Step S271). In this case, the communication control unit 305 allocates a communication resource to a task requesting a communication resource by the fifth instruction 110 in preference to a task requesting a communication resource by the seventh instruction 112 among tasks requesting a communication resource.

After reserving a communication resource in accordance with the fifth instruction 110, the scheduling system 301 assigns processing of the second part 107 to the many-core accelerator 102. The scheduling system 301 reserves a communication resource in accordance with the seventh instruction 112 after the many-core accelerator 102 completes processing of the second part 107. The scheduling system 301 processes a task 106 commanding the fifth instruction 110 in preference to a task 106 commanding the seventh instruction 112. Thus, the many-core accelerator 102 is able to transmit/receive data related to the second part 107 early via a communication resource. Consequently, processing efficiency in the many-core accelerator 102 becomes yet higher compared with the ninth exemplary embodiment.

For example, a predetermined priority order assignment method illustrated in FIG. 34 is a method in which a higher priority order is assigned in order of time of requesting a communication resource when a same instruction type is associated therewith, in addition to the assignment method illustrated in FIG. 33 (that is, Step S271). In other words, the predetermined priority order assignment method is a method in which a higher priority order is assigned in order of time among tasks 106 associated with the instruction type “5” (Step S272). Further, the predetermined priority order assignment method is a method in which a higher priority order is assigned in order of time among tasks 106 associated with the instruction type “7” (Step S273). Step S273 may be processed prior to Step S272.

In the predetermined priority order assignment method illustrated in FIG. 34, a higher priority order is assigned in order of time of requesting a communication resource. Thus, in the predetermined priority order assignment method, an average turnaround time required for processing a task can be shortened in addition to the effect exhibited by the predetermined priority order assignment method illustrated in FIG. 33.

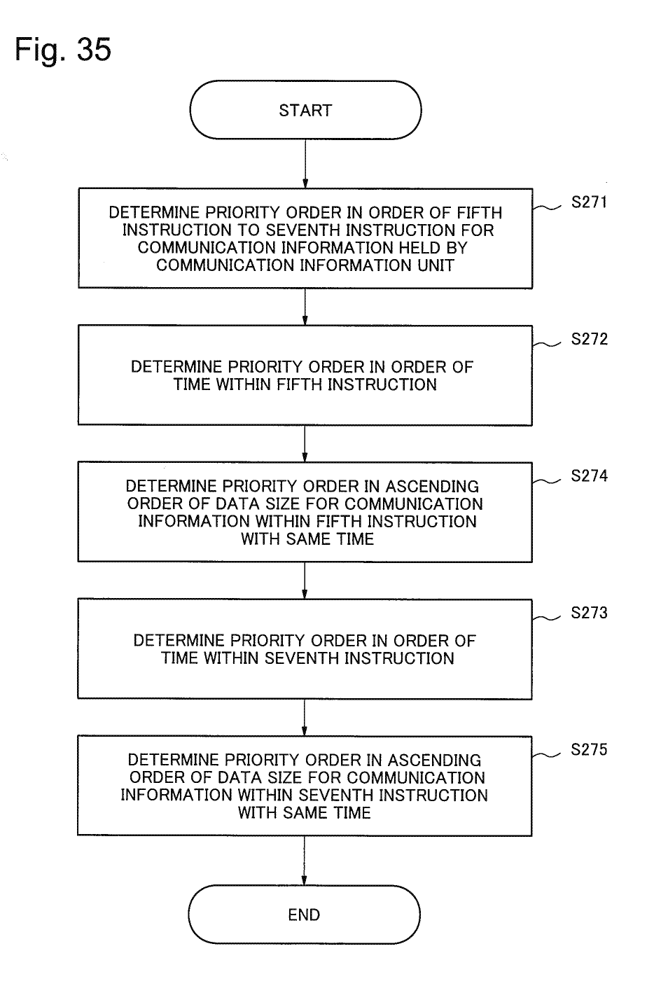

Further, for example, a predetermined priority order assignment method illustrated in FIG. 35 is a method in which a subsequent process is performed when tasks are associated with a same time, in addition to the predetermined priority order assignment method illustrated in FIG. 34. In other words, the predetermined priority order assignment method illustrated is a method in which a higher priority order is assigned to a task 106 with a smaller size of data to be transmitted/received between the accelerator memory 104 and the main memory 103.

In other words, the predetermined priority order assignment method assigns a higher priority order to a task 106 with a smaller size of the data among tasks associated with an instruction type “5” and a same time (Step S274). Further, the predetermined priority order assignment method assigns a higher priority order to a task with a smaller size of the data among tasks associated with an instruction type “7” and a same time (Step S275). The processes may be performed in the order of Steps S271, S273, S275, S272, and S274.

The present exemplary embodiment provides the task 106 with shorter waiting time in communication resource allocation.

When the scheduling system 301 allocates a communication resource to a first task, a second task in the communication information unit 304 waits for the communication resource to be released. As a size of data transmitted/received between the accelerator memory 104 and the main memory 103 becomes larger, it takes longer time to transmit/receive the data, thus a task waiting time for communication resource allocation becomes longer. According to the present exemplary embodiment, a task with a smaller size of data is assigned a higher priority order, therefore, the aforementioned waiting time is short.

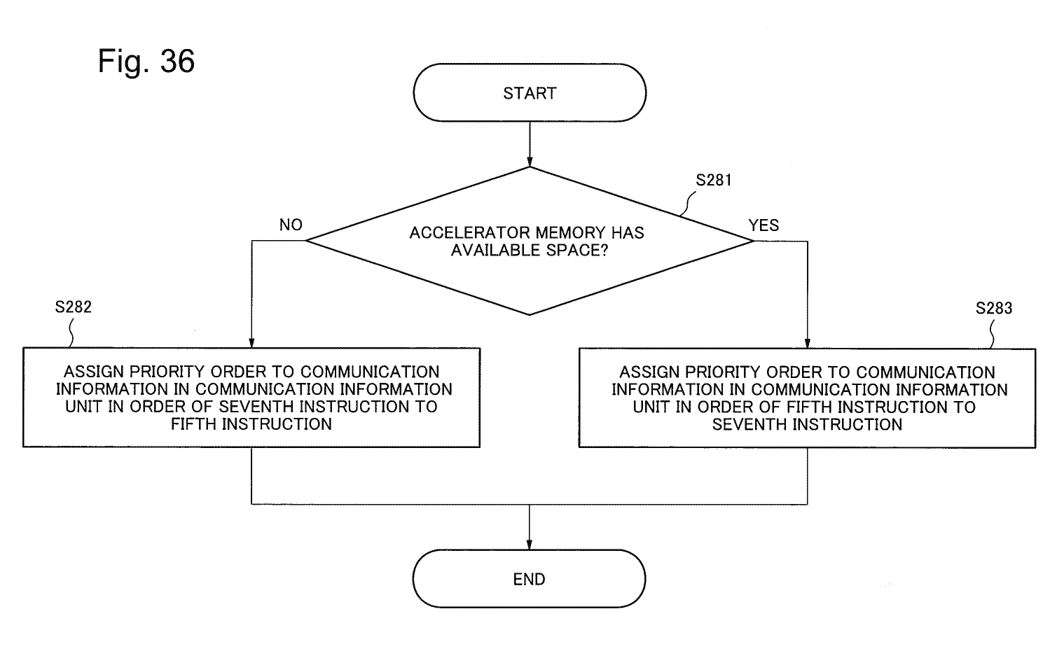

Further, for example, a predetermined priority order assignment method illustrated in FIG. 36 will be described below. According to the method, for example, when there is a storage area in an unused state in the accelerator memory 104 (YES in Step S281), a priority order is assigned (Step S283). In this case, the predetermined priority order assignment method is a method in which a task associated with the fifth instruction 110 is assigned a higher priority order than a task associated with the seventh instruction 112.

Further, according to the method, when there is no storage area in an unused state in the accelerator memory 104 (NO in Step S281), a priority order is assigned (Step S282). In this case, the predetermined priority order assignment method is a method in which a task associated with the seventh instruction 112 is assigned a higher priority order than a task associated with the fifth instruction 110.

When there is no storage area in an unused state in the accelerator memory 104, the scheduling system 301 can allocate a communication resource in accordance with the fifth instruction 110. However, the host processor 101 is not able to transmit data required for processing in the second part 107 to the accelerator memory 104. In this case, the scheduling system 301 reserves a storage area in an unused state in the accelerator memory 104 and transmits the required data to the storage area in an unused state. Thus, the many-core accelerator 102 starts processing in the second part 107.

In other words, when there is no storage area in an unused state in the accelerator memory 104, the communication channel scheduler 302 assigns a high priority order to a task 106 associated with the seventh instruction 112. Thus, the communication channel scheduler 302 first reserves a storage area in an unused state in the accelerator memory 104. The host processor 101 transmits the referenced data from the main memory 103 to the storage area in an unused state. Then, the many-core accelerator 102 performs processing in the second part 107 on the basis of the data.

In other words, the communication channel scheduler 302 according to the present exemplary embodiment allocates a communication resource depending on usage status of the accelerator memory 104. Therefore, the communication channel scheduler 302 reduces possibility that, although there is no sufficient storage area to store data for processing a task in the accelerator memory 104, a communication resource for transmitting the data is allocated to the task. Thus, the communication channel scheduler 302 according to the present exemplary embodiment is able to reduce possibility of processing in the many-core accelerator 102 being halted due to the accelerator memory 104 not being able to store data to be processed by a task 106.

Since the tenth exemplary embodiment includes a similar configuration to the ninth exemplary embodiment, the tenth exemplary embodiment can enjoy the similar effect to the ninth exemplary embodiment. In other words, the scheduling system 301 according to the tenth exemplary embodiment is capable of more efficiently enabling processing performance possessed by a resource to be exhibited.

### Eleventh Exemplary Embodiment

Next, an eleventh exemplary embodiment based on the aforementioned fourth exemplary embodiment will be described.

In the following description, characteristic matters according to the present exemplary embodiment will be mainly described and an overlapping description of the same configuration as in the aforementioned fourth exemplary embodiment will be omitted by assigning the same reference sign thereto.

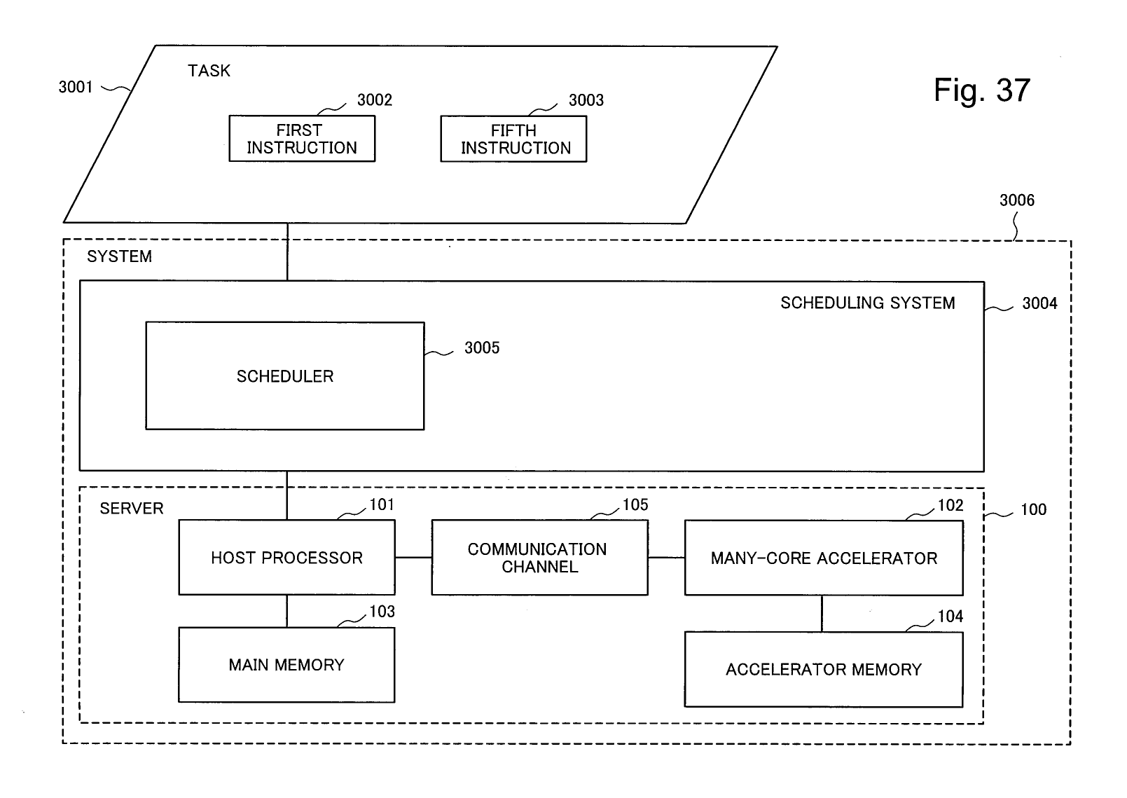

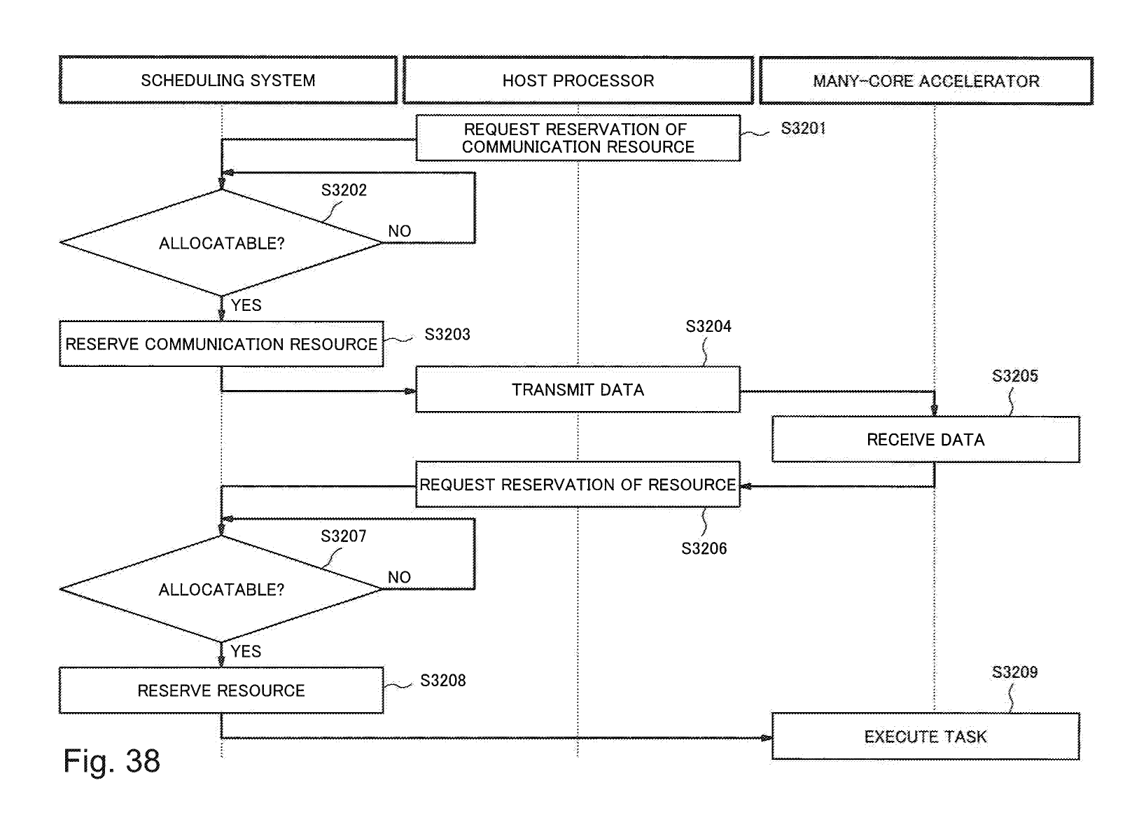

Referring to FIGS. 37 and 38, a configuration included in a scheduling system 3004 according to the eleventh exemplary embodiment of the present invention and processes performed by the scheduling system 3004 will be described. FIG. 37 is a block diagram illustrating a configuration of the scheduling system 3004 according to the eleventh exemplary embodiment of the present invention. FIG. 38 is a sequence diagram illustrating a flow of processes in the scheduling system 3004 according to the eleventh exemplary embodiment.

A system 3006 includes a server 100 and the scheduling system 3004.

The scheduling system 3004 includes a scheduler 3005.

First, the scheduler 3005 controls the server 100 on the basis of a task 3001 including a first instruction 3002 for reserving a resource included in a many-core accelerator 102 and a fifth instruction 3003 for reserving a communication resource included in a communication channel 105.

A host processor 101 transmits a request for reserving a communication resource capable of communicating an amount instructed by the fifth instruction 3003 to the scheduler 3005 in accordance with the fifth instruction 3003 in the task 3001, (Step S3201).

Next, the scheduler 3005 decides whether or not there is a communication resource in an unused state in the communication channel 105 in response to receiving the request (Step S3202). When a communication resource capable of communicating the amount instructed by the fifth instruction is decided to be allocatable from the communication channel 105 (YES in Step S3202), the scheduler 3005 reserves the communication resource (Step S3203).

Next, the host processor 101 reads data to be processed by the task 3001 from a main memory 103 and transmits the read data to the many-core accelerator 102 (Step S3204). Then, the many-core accelerator 102 receives the data and stores the received data in an accelerator memory 104 (Step S3205).

Next, the host processor 101 transmits a request for reserving a resource for processing the task 3001 out of the many-core accelerator 102 to the scheduler 3005 in accordance with the first instruction 3002 (Step S3206).

The scheduler 3005 receives the request and decides whether or not a resource based on the first instruction 3002 can be reserved in the many-core accelerator 102 (Step S3207). When the many-core accelerator 102 is decided to include an unused-state resource to process the task 3001 (YES in Step S3207), the scheduler 3005 reserves a specific resource (Step S3208).

Next, the specific resource performs processing related to the task 3001 on the basis of the received data in the accelerator memory 104 (Step S3209).

Since the eleventh exemplary embodiment includes a similar configuration to the fourth exemplary embodiment, the eleventh exemplary embodiment can enjoy the similar effect to the fourth exemplary embodiment. In other words, the scheduling system 3004 according to the eleventh exemplary embodiment is capable of more efficiently enabling processing performance possessed by a resource to be exhibited.

Further, the scheduling system 3004 reserves a communication channel resource that transmits first data related to the task 3001 out of the communication channel 105. When the scheduler 3005 reserves a communication resource, the first data in the main memory 103 can be stored in the accelerator memory 104 without delay by the host processor. Consequently, a situation in which, although the scheduler 3005 reserves a specific resource, the specific resource is not able to perform processing related to the task 3001 due to delay of the first data, does not occur.

In other words, the scheduling system 3004 according to the present exemplary embodiment is capable of yet more efficiently enabling processing performance possessed by a resource to be exhibited in addition to the aforementioned effects.

### Hardware Configuration Example

A configuration example of a hardware resource realizing a scheduling system according to each exemplary embodiment of the present invention described above with a single calculation processing apparatus (information processing apparatus, computer) will be described. Such a scheduling system may be physically or functionally realized by use of at least two calculation processing apparatuses. Further, such a scheduling system may be realized as a dedicated apparatus.

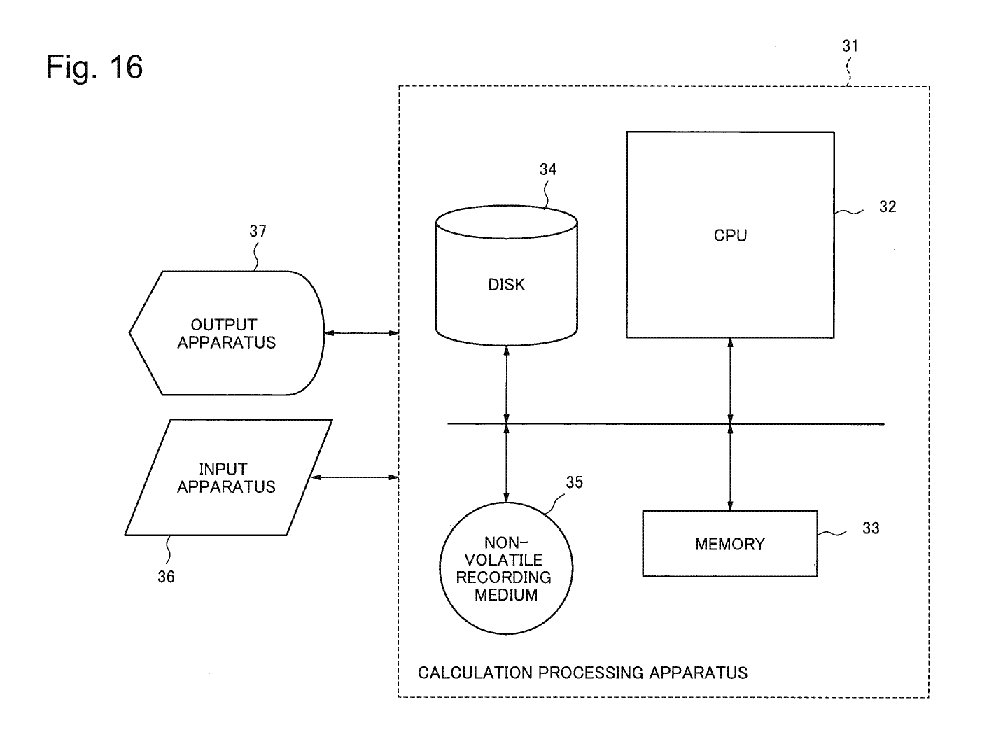

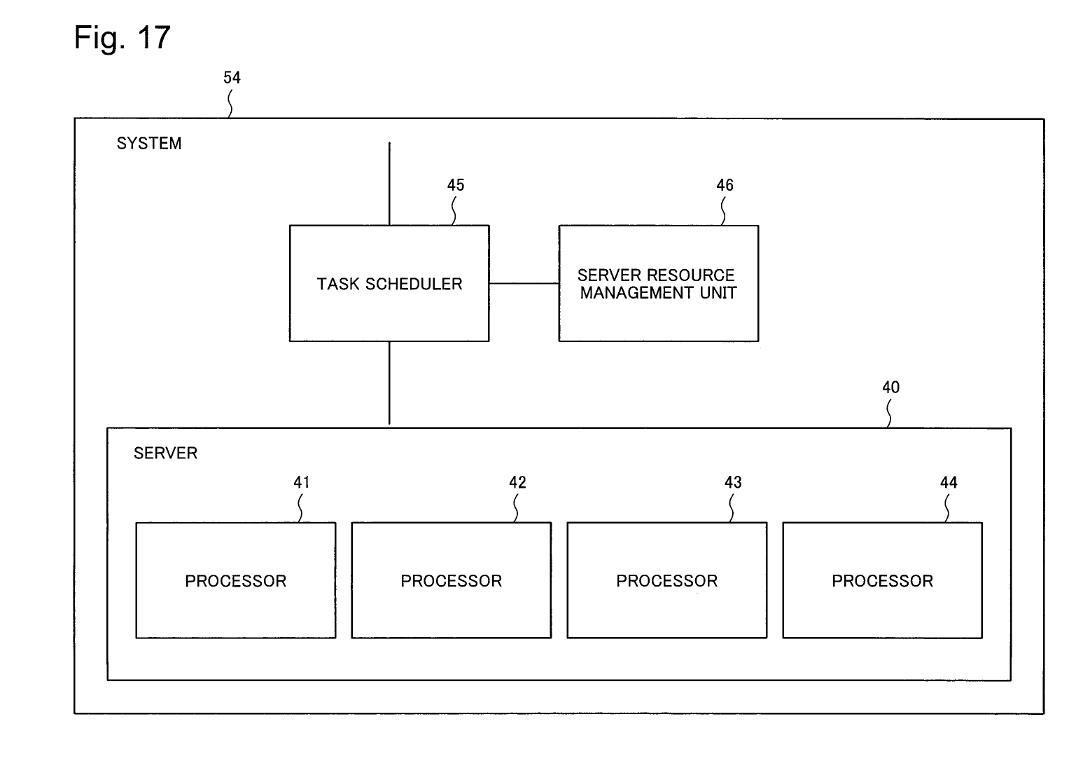

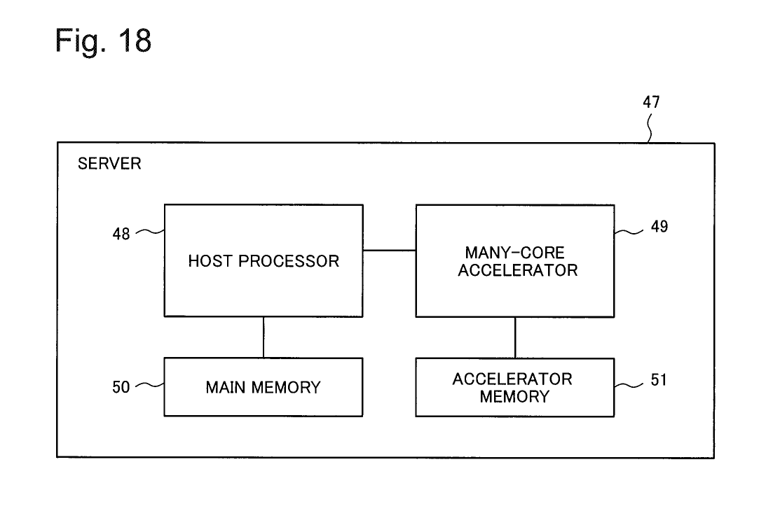

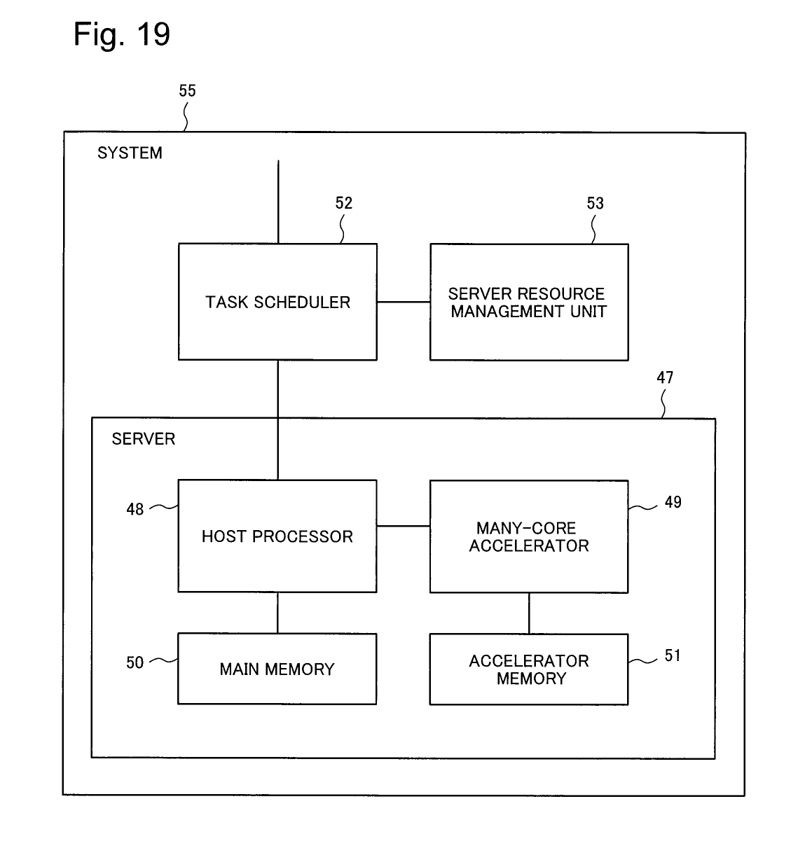

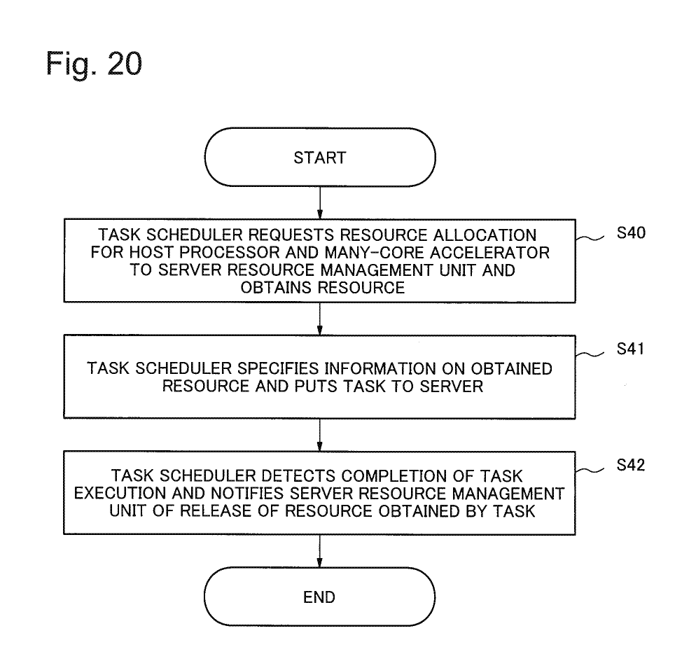

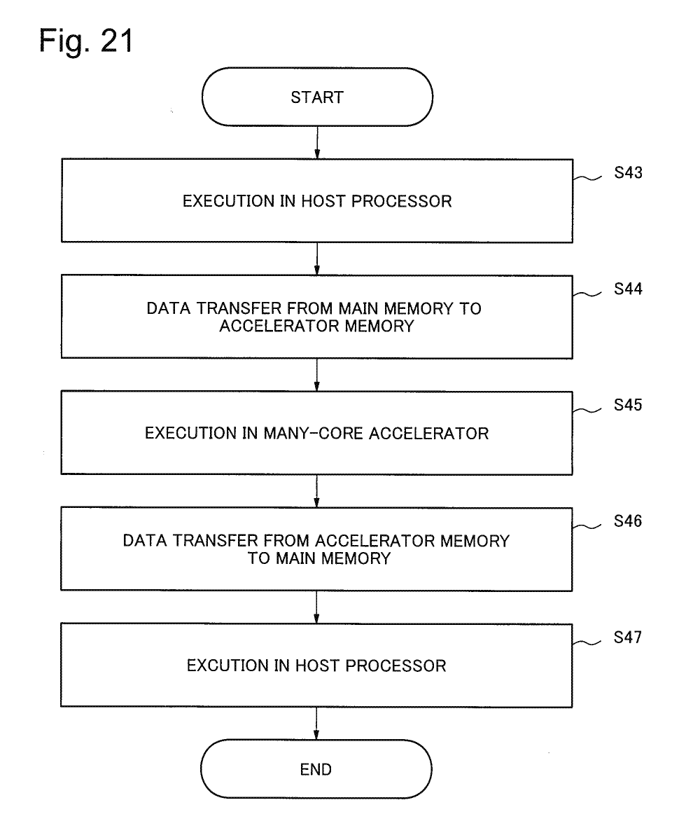

FIG. 16 is a schematic diagram illustrating a hardware configuration of a calculation processing apparatus capable of realizing a scheduling system according to the first to eleventh exemplary embodiments. A calculation processing apparatus 31 includes a Central Processing Unit (hereinafter abbreviated as “CPU”) 32, a memory 33, a disk 34, a non-volatile recording medium 35, an input apparatus 36, and an output apparatus 37.

The non-volatile recording medium 35 refers to, for example, a Compact Disc, a Digital Versatile Disc, a Blu-ray Disc (registered trademark), a Universal Serial Bus memory (USB memory), Solid State Drive, etc. that are computer-readable, capable of holding such a program without power supply, and portable. The non-volatile recording medium 35 is not limited to the aforementioned media. Further, such a program may be transferred via a communication network instead of the non-volatile recording medium 35.

When executing a software program (computer program, hereinafter simply referred to as “program”) stored in the disk 34, the CPU 32 copies the program to the memory 33 and performs arithmetic processing. The CPU 32 reads data required for executing the program from the memory 33. When a display is required, the CPU 32 displays an output result on the output apparatus 37. When inputting a program from outside, the CPU 32 reads the program from the input apparatus 36. The CPU 32 interprets and executes a scheduling program (processes performed by the scheduling system in FIGS. 2, 4, 6, 8, 9, 11, 13, 15, 23, 24, 26, 27, 30, 31, 33 to 36, and 38) in the memory 33 corresponding to a function (process) represented by each unit in the aforementioned FIG. 1, 3, 5, 7, 10, 12, 14, 22, 25, 29, or 37. The CPU 32 sequentially performs processes described in each of the aforementioned exemplary embodiments of the present invention.

In such a case, the present invention can be regarded as realizable also by such a scheduling program. Further, the present invention can be regarded as realizable also by a computer-readable recording medium containing such a scheduling program.

The aforementioned respective exemplary embodiments may also be described in whole or part as the following Supplemental Notes. However, the present invention exemplified in each of the aforementioned exemplary embodiments is not limited to the following.

### (Supplemental Note 1)

A scheduling system including a scheduler configured to reserve a second communication channel, that is capable of transmitting/receiving a first data processed by a task between the memory and the accelerator memory, as a second communication resource in accordance with a fifth instruction for reserving the second communication channel from a first communication channel that is capable of transmitting/receiving data between a many-core accelerator to be a resource and a processor which controls the resource, and determine a specific resource for processing the task by referring to the first data transmitted/received via the second communication resource in accordance with a first instruction for reserving the resource; wherein

the task is processed by a calculation processing apparatus which includes the many-core accelerator, an accelerator memory accessed by the many-core accelerator, the processor, a memory accessed by the processor, and a first communication channel.

### (Supplemental Note 2)

The scheduling system according to Supplemental Note 1, wherein, based on the task including a first part processed by the processor, the fifth instruction, a third part that is an instruction for transmitting the first data from the memory to the accelerator memory via the second communication resource, a sixth instruction for releasing the second communication resource, a first instruction for reserving a resource processing the task from the resource, a second part that is an instruction for processing the task by the reserved resource, a seventh instruction for reserving, from the first communication channel, a third communication channel capable of transmitting/receiving second data transmitted from the accelerator memory to the memory, a fourth part that is an instruction for transmitting the second data from the accelerator memory to the memory via the third communication channel, an eighth instruction for releasing the third communication channel, and a second instruction for releasing the reserved resource processing the task, the scheduler includes a communication channel scheduler that reserves the second communication resource in accordance with the fifth instruction, releases the second communication resource in accordance with the sixth instruction, reserves the third communication channel as a third communication resource in accordance with the seventh instruction, and releases the third communication resource in accordance with the eighth instruction,

the scheduler reserves a resource for processing the task as a specific resource in accordance with the first instruction during execution of the first part by the processor and execution of the third part by the processor and releases the specific resource in accordance with the second instruction after execution of the fourth part by the processor,

the processor transmits the first data from the memory to the accelerator memory via the second communication resource and transmits the second data from the accelerator memory to the memory via the third communication resource, and

the specific resource generates the second data by processing the task while accessing the first data in accordance with the second part.

### (Supplemental Note 3)

The scheduling system according to Supplemental Note 2, wherein the communication channel scheduler reserves a fourth communication resource from a communication channel in an unused state in the first communication channel in accordance with the fifth instruction or the seventh instruction, and does not reserve the fourth communication resource when the first communication channel does not include the communication channel in an unused state.

### (Supplemental Note 4)

The scheduling system according to Supplemental Note 3, wherein

the task is associated with a task identifier that identifies a task, and

the communication channel scheduler includes:

communication information means capable of storing the task identifier,

communication control means for storing the task identifier associated with the task in the communication information means when the fourth communication resource cannot be reserved for the task executing the fifth instruction or the seventh instruction and performing communication control processing that reserves the fourth communication resource from the first communication channel in the unused state when the fourth communication resource can be reserved, and

releasing the fourth communication resource in accordance with the sixth instruction or the eighth instruction, reading the task identifier from the communication information means, and performing the communication control processing on the task associated with the read task identifier.

### (Supplemental Note 5)

The scheduling system according to Supplemental Note 4, that includes

priority order setting means configured to, in accordance with a predetermined priority order assignment method, calculate a priority order of processing a task associated with a task identifier in the communication information means depending on a type of instruction executed by the task, wherein

the communication control means reads the task identifier from the communication information means on the basis on the priority order.

### (Supplemental Note 6)

The scheduling system according to Supplemental Note 5, wherein

the predetermined priority order assignment method is a method that assigns a higher value of the priority order to a task with the instruction type to be the fifth instruction than a task with the instruction type to be the seventh instruction.

### (Supplemental Note 7)

The scheduling system according to Supplemental Note 5, wherein

the predetermined priority order assignment method is a method that assigns a higher value of the priority order to a task that executes the fifth instruction earlier among tasks with the instruction type to be the fifth instruction.

### (Supplemental Note 8)

The scheduling system according to Supplemental Note 7, wherein

the predetermined priority order assignment method is a method that assigns a higher value of the priority order to a task that executes the seventh instruction earlier among tasks with the instruction type to be the seventh instruction.

### (Supplemental Note 9)

The scheduling system according to Supplemental Note 5, wherein

the predetermined priority order assignment method is a method that assigns a higher value of the priority order to a task that transmits a less amount of data via the communication channel among tasks with the instruction type to be the fifth instruction or the seventh instruction.

### (Supplemental Note 10)

The scheduling system according to Supplemental Note 5, wherein

the predetermined priority order assignment method is a method that assigns a higher priority order to a task with the instruction type to be the fifth instruction than a task with the instruction type to be the seventh instruction when a storage area in an unused state capable of storing the data in the accelerator memory is decided to exist, and assigns a higher value of the priority order to a task with the instruction type to be the seventh instruction than a task with the instruction type to be the fifth instruction when the storage area is decided not to exist.

### (Supplemental Note 11)

An operating system that includes the scheduling system according to any one of Supplemental Notes 1 to 10.

### (Supplemental Note 12)

A scheduling method comprising:

reserving a second communication channel, that is capable of transmitting/receiving a first data processed by a task between the memory and the accelerator memory, as a second communication resource in accordance with a fifth instruction for reserving the second communication channel from a first communication channel that is capable of transmitting/receiving data between a many-core accelerator to be a resource and a processor which controls the resource; and

determining a specific resource for processing the task by referring to the first data transmitted/received via the second communication resource in accordance with a first instruction for reserving the resource; wherein

the task is processed by a calculation processing apparatus which includes the many-core accelerator, an accelerator memory accessed by the many-core accelerator, the processor, a memory accessed by the processor, and a first communication channel.

### (Supplemental Note 13)

A recording medium storing a scheduling program that causes a computer to realize a scheduling function, the function comprising:

reserving a second communication channel, that is capable of transmitting/receiving a first data processed by a task between the memory and the accelerator memory, as a second communication resource in accordance with a fifth instruction for reserving the second communication channel from a first communication channel that is capable of transmitting/receiving data between a many-core accelerator to be a resource and a processor which controls the resource; and

determining a specific resource for processing the task by referring to the first data transmitted/received via the second communication resource in accordance with a first instruction for reserving the resource; wherein

the task is processed by a calculation processing apparatus which includes the many-core accelerator, an accelerator memory accessed by the many-core accelerator, the processor, a memory accessed by the processor, and a first communication channel.

The present invention has been described with the aforementioned exemplary embodiments as exemplary examples. However, the present invention is not limited to the aforementioned exemplary embodiments. In other words, various embodiments that can be understood by those skilled in the art may be applied to the present invention, within the scope thereof.

This application claims priority based on Japanese Patent Application No. 2013-109843 filed on May 24, 2013, the disclosure of which is hereby incorporated by reference thereto in its entirety.

### REFERENCE SIGNS LIST

1 Scheduling system
2 Scheduler
3 Server
4 Host processor
5 Many-core accelerator
6 Task
7 Scheduling system
8 Scheduler
9 Management unit
10 Scheduling system
11 Scheduler
12 Task
13 Scheduling system
14 Scheduler
15 Task
16 Server
17 Many-core accelerator
18 Host processor
19 Main memory
20 Accelerator memory
21 Scheduling system
22 Scheduler
23 Task
24 Scheduling system
25 Scheduler
26 Second task scheduler
27 Scheduling system
28 Scheduler
29 Management unit
30 Second task scheduler
31 Calculation processing apparatus
32 CPU
33 Memory
34 Disk
35 Non-volatile recording medium
36 Input apparatus
37 Output apparatus
38 System
39 System
40 Server
41 Processor
42 Processor
43 Processor
44 Processor
45 Task scheduler
46 Server resource management unit
47 Server
48 Host processor
49 Many-core accelerator
50 Main memory
51 Accelerator memory
52 Task scheduler
53 Server resource management unit
54 System
55 System
56 System
57 System
58 System
59 System
60 System
100 Server
101 Host processor
102 Many-core accelerator
103 Main memory
104 Accelerator memory
105 Communication channel
106 Task
107 Second part
108 Third part
109 Fourth part
110 Fifth instruction
111 Sixth instruction
112 Seventh instruction
113 Eighth instruction
117 System
201 First instruction
202 Second instruction
114 Scheduling system
115 Scheduler
116 Communication channel scheduler
117 System
251 Scheduling system
252 Communication channel scheduler
253 Communication control unit
254 Communication information unit
255 System
301 Scheduling system
302 Communication channel scheduler
303 Priority order setting unit
304 Communication information unit
305 Communication control unit
306 System
3001 Task
3002 First instruction
3003 Fifth instruction
3004 Scheduling system
3005 Scheduler
3006 System

What is claimed is:

1.-10. (canceled)

11. A scheduling system comprising:
a scheduler configured to reserve a second communication channel, that is capable of transmitting/receiving a first data processed by a task between the memory and the accelerator memory, as a second communication resource in accordance with a fifth instruction for reserving the second communication channel from a first communication channel that is capable of transmitting/receiving data between a many-core accelerator to be a resource and a processor which controls the resource, and determine a specific resource for processing the task by referring to the first data transmitted/received via the second communication resource in accordance with a first instruction for reserving the resource; wherein
the task is processed by a calculation processing apparatus which includes the many-core accelerator, an accelerator memory accessed by the many-core accelerator, the processor, a memory accessed by the processor, and a first communication channel.

12. The scheduling system according to claim 11, wherein
based on the task including a first part processed by the processor, the fifth instruction, a third part that is an instruction for transmitting the first data from the memory to the accelerator memory via the second communication resource, a sixth instruction for releasing the second communication resource, a first instruction for reserving a resource processing the task from the resource, a second part that is an instruction for processing the task by the reserved resource, a seventh instruction for reserving, from the first communication channel, a third communication channel capable of transmitting/receiving second data transmitted from the accelerator memory to the memory, a fourth part that is an instruction for transmitting the second data from the accelerator memory to the memory via the third communication channel, an eighth instruction for releasing the third communication channel, and a second instruction for releasing the reserved resource processing the task, the scheduler includes a communication channel scheduler that reserves the second communication resource in accordance with the fifth instruction, releases the second communication resource in accordance with the sixth instruction, reserves the third communication channel as a third communication resource in accordance with the seventh instruction, and releases the third communication resource in accordance with the eighth instruction,
the scheduler reserves a resource for processing the task as a specific resource in accordance with the first instruction during execution of the first part by the processor and execution of the third part by the processor and releases the specific resource in accordance with the second instruction after execution of the fourth part by the processor,
the processor transmits the first data from the memory to the accelerator memory via the second communication resource and transmits the second data from the accelerator memory to the memory via the third communication resource, and
the specific resource generates the second data by processing the task while accessing the first data in accordance with the second part.

13. The scheduling system according to claim 12, wherein
the communication channel scheduler reserves a fourth communication resource from a communication channel in an unused state in the first communication channel in accordance with the fifth instruction or the seventh instruction, and does not reserve the fourth communication resource when the first communication channel does not include the communication channel in an unused state.

14. The scheduling system according to claim 13, wherein
the task is associated with a task identifier that identifies a task, and
the communication channel scheduler includes:
communication information unit capable of storing the task identifier,
communication control unit for storing the task identifier associated with the task in the communication information unit when the fourth communication resource cannot be reserved for the task executing the fifth instruction or the seventh instruction and performing communication control processing that reserves the fourth communication resource from the first communication channel in the unused state when the fourth communication resource can be reserved, and
releasing the fourth communication resource in accordance with the sixth instruction or the eighth instruction, reading the task identifier from the communication information unit, and performing the communication control processing on the task associated with the read task identifier.

15. The scheduling system according to claim 14 further comprising:
priority order setting unit configured to, in accordance with a predetermined priority order assignment method, calculate a priority order of processing a task associated with a task identifier in the communication information unit depending on a type of instruction executed by the task, wherein
the communication control unit reads the task identifier from the communication information unit on the basis on the priority order.

16. The scheduling system according to claim 15, wherein
the predetermined priority order assignment method is a method that assigns a higher value of the priority order to a task with the instruction type to be the fifth instruction than a task with the instruction type to be the seventh instruction.

17. The scheduling system according to claim 15, wherein
the predetermined priority order assignment method is a method that assigns a higher value of the priority order to a task that executes the fifth instruction earlier among tasks with the instruction type to be the fifth instruction.

18. The scheduling system according to claim 17, wherein
the predetermined priority order assignment method is a method that assigns a higher value of the priority order to a task that executes the seventh instruction earlier among tasks with the instruction type to be the seventh instruction.

19. A scheduling method comprising:
reserving a second communication channel, that is capable of transmitting/receiving a first data processed by a task between the memory and the accelerator memory, as a second communication resource in accordance with a fifth instruction for reserving the second communication channel from a first communication channel that is capable of transmitting/receiving data between a many-core accelerator to be a resource and a processor which controls the resource; and
determining a specific resource for processing the task by referring to the first data transmitted/received via the second communication resource in accordance with a first instruction for reserving the resource; wherein
the task is processed by a calculation processing apparatus which includes the many-core accelerator, an accelerator memory accessed by the many-core accelerator, the processor, a memory accessed by the processor, and a first communication channel.

20. A recording medium storing a scheduling program that causes a computer to realize a scheduling function, the function comprising:
reserving a second communication channel, that is capable of transmitting/receiving a first data processed by a task between the memory and the accelerator memory, as a second communication resource in accordance with a fifth instruction for reserving the second communication channel from a first communication channel that is capable of transmitting/receiving data between a many-core accelerator to be a resource and a processor which controls the resource; and
determining a specific resource for processing the task by referring to the first data transmitted/received via the second communication resource in accordance with a first instruction for reserving the resource; wherein
the task is processed by a calculation processing apparatus which includes the many-core accelerator, an accelerator memory accessed by the many-core accelerator, the processor, a memory accessed by the processor, and a first communication channel.

21. The scheduling system according to claim 15, wherein
the predetermined priority order assignment method is a method that assigns a higher value of the priority order to a task that transmits a less amount of data via the communication channel among tasks with the instruction type to be the fifth instruction or the seventh instruction.

22. The scheduling system according to claim 15, wherein
the predetermined priority order assignment method is a method that assigns a higher priority order to a task with the instruction type to be the fifth instruction than a task with the instruction type to be the seventh instruction when a storage area in an unused state capable of storing the data in the accelerator memory is decided to exist, and assigns a higher value of the priority order to a task with the instruction type to be the seventh instruction than a task with the instruction type to be the fifth instruction when the storage area is decided not to exist.

23. An operating system that includes the scheduling system according to claim 11.
